(19) United States
(12) Patent Application Publication
(10) Pub. No.: US 2013/0311348 A1
(43) Pub. Date: Nov. 21, 2013

(54) Fitting digital currency into modern transactional ecosystems

(71) Applicant: Gideon Samid, Rockville, MD (US)

(72) Inventor: Gideon Samid, Rockville, MD (US)

(21) Appl. No.: 13/815,564

(22) Filed: Mar. 11, 2013

Related U.S. Application Data
(60) Provisional application No. 61/634,943, filed on Mar. 9, 2012.

(51) Int. Cl. G06Q 40/00

(52) U.S. Cl. CPC G06Q 40/00
USPC 705/37; 705/44; 705/35

(57) ABSTRACT

This application described methods and means to construct a viable trading ecosystem for digital currency, gradually rising to local, and global prominence as the modern way to represent money. The application regards various media options to express the digital bit sequence which reflects the monetary value and the identity of the digital coin, including hard copies, and electronic variety. It Describes the ways to fuse a digital coin with any well defined terms of payments, and how to manage such coins as they are forwarded for redemption. The application describes various security means to insure the integrity of the digital mint. It also describes how to construct a hierarchy of authentication nodes such that each node has sufficient information to authenticate a digital coin, but not sufficient information to defraud a higher-up node. The application also describes how to inter-relate any number of independent digital mints so as to mutually honor each others' coins and thereby appear to the trader as a single mint.

### CROSS REFERENCE TO RELATED APPLICATIONS

This application claims as priority date provisional application filed by the same inventor, Application No. 61,634,943 filed on Mar. 9, 2012 entitled: “Innovation Package G22” and it also claims as reference U.S. Pat. No. 8,229,859

### BRIEF SUMMARY OF THE INVENTION

Digital Currencies have been proposed and shown to be a modern viable transactional platform. And in order to mint them, redeem them, manage their distribution, and exercise their full capacity it is necessary to construct proper mints, security features, and coin representation options, to fit into the tools people use, and to the transactional practice of the modern global trader. This invention offers novel mint construction where convenience, efficacy, and security reach a happy optimum. The invention also offers distribution options, and digital coin representations to afford smooth transactional dynamics. Since the integrity of the mint is the center piece of the system security, this invention offers means to insure that integrity. Since coin validation and redemptions are central to the daily process of digital transactions, this invention describes a hierarchy of redemption nodes. This invention also focuses on the use of the telephone as a point of sales terminal, and this invention also points out physical means to insure the integrity of physical coins that may be turned into electronic coins (hybrid coins).

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

Same inventor was granted a patent for digital currency (U.S. Pat. No. 8,229,859)—a new form of money never used before. In order to make a go of it, it is necessary to innovate means to mint such currency, provide for its security in motion, and at rest, and allow for a variety of developers to have a foundational system on which to build robust payment tools. This need led to this invention of methods and tools for fitting digital currency to modern transactional ecosystems.

### DETAILED DESCRIPTION OF THE INVENTION

This invention relates to: Technology, Security, Applications for operating a digital currency in our modern reality. Technology will be discussed per: Mint technology, Trading Technology, Coin Technology.

Mint Technology: Categories: Mint Construction and Operation

Validation Hierarchy Technology, Mint Compliance Technology, InterMint

The Mint is a highly secure hub—the heart of the BitMint environment; it generates the BitMint coins, redeems them, and validates them. The validation hierarchy is a hierarchy type network of nodes, designed for local, easy, and otherwise advantageous service of coin validation and redemption. The Mint compliance technology is the system that is designed to satisfy all applicable laws and regulations to insure broad applicability and acceptability of the BitMint operation. The Inter-Mint is the part of the Mint that is interfacing with sister mints to provide convenient gateways for traders crossing from one BitMint sphere to another.

Mint Construction & Operations:

The Mint is comprised of:

Control Module, Interface Module, Financial Module, Coin Generation Module, Coin Database Module, Mint Auxiliary Module

The Mint Operations comprise:

Public Interfacing, Financial Management, Coin Database Management, Coin Generation, Drop-Dead Backup,

### Mint Components: Components

Four modules under central control.

Mint Control Module, Interface Module, Financial Module, Generation Module, Coin Database Module.

### Mint Control Module

This module runs the entire Mint, keeps track of Mint events, and provides good visibility to the Mint operators.

### The Interface

This Module has Three Interfaces:

Traders Interface, Validation Hierarchy Interface, Mint Compliance Interface, Inter-Mint Interface.

The Traders Interface manages the communication with traders of the BitMint money. It accommodates the requests for BitMint coins; it validates coins, exchanges coins, and it redeems BitMint coins. This module does all the above with the help of the other modules. The Validation Hierarchy Interface is handling coin validation data with nodes in the validation hierarchy (VH). The Mint compliance Interface is handling real time instructions, and requirements from the applicable authorities regarding financial activity. The Inter-Mint is the part of the Mint that is interfacing with sister mints to provide convenient gateways for traders crossing from one BitMint sphere to another.

### Financial Module

The financial module handles the conversion between BitMint money to the reference money, (the fiat currency) against which the mint works. It insures the integrity of money paid both directions, insures the proper accounting of money at hand and profits accumulated. This modules also connects with any financial institutions the BitMint deals with.

### Coin Generation Module

This modules is exercising the core minting of the operation. It generates BitMint coins per demand. As a matter of policy BitMint coins may not be generated ahead of their delivery since this would create a coin theft vulnerability.

### Coin Database Module

This module handles the coin database: the massive listing of all coins issued, keeping a mirror image of nearly all the information that was impressed on each BitMint coin. This massive database will have to be guarded with the best security measures. It will be indexed per its coin id, and will be specially accommodating because the file lengths are variable, as they reflect the coin value.

### Mint Operation:

The Mint Operations Comprise:
Public Interfacing
Financial Management
Coin Database Management
Coin Generation
Drop-Dead Backup

### Public Interfacing

BitMint website will be tasked with interfacing with the public. Main activities:
Minting of coins
Validating coins
Redeeming coins
explaining, training, updating, and notifications

### Coin Generation

For reasons of security it is desired to mint the coin upon its release to a trader, and not ahead of that time. This implies that a source of BitMint bits will have to be exercised upon the actual demand for a BitMint coin.

One way to accomplish this is to monitor a radioactive source, and interpret as 1 any radiation count within a time framework of T, that is above the average of the count over many T intervals, and interpret as zero any radiation count within that T time frame, that is beneath the average value of the radiation count. Alternatively, one would select an interval of time, T, and measure the total radiation counts within successive time intervals of T. Each interval where the count was higher than the count in the interval before will be regarded as “1”; each interval where the count was lower than the count in the interval before will be regarded as “0”. For a radioactive material of sufficiently long half life time, this procedure will yield a string of random bits. One could increase at will the quantity of the radioactive material, and thereby decrease the value of T (the length of the time interval). The smaller the value of the time interval T, the faster the coin generation. This way the mint productivity can be adjusted. These randomly generated bits will be minted into a full coin, alongside its header, and trailer if need be.

There are several considerations is setting up the bit-per-currency exchange rate. E.g.: how many bits will represent a single dollar. A small number will allow for shorter coins which may be important for physical coins. A large number will increase the security especially for small denominations. It will also increase the ability to generate several generations in the validation hierarchy.

Drop-Dead Backup

A selected small number of bits minted for any newly generated coin, will be written on a write-only-not-read media apparatus. These, so called ‘drop dead’ bits, secured on this no read back media, will be only readable following a dedicated hand operated, contact necessary operation to be performed on the media that captures those drop-dead bits. This will assure that no amount of smarts or sophistication of a hacker would be able to read back these drop dead bits and compromise the BitMint. Hopefully there would never be a need to read back those bits, but should such a need develop, the operator will have to manually handle the device to read these deeply stored bits.

One implementation of the drop dead procedure will be to simply create a hard copy of these bits, and then secure the papers in a vaulted box.

The drop-dead bits will not be recorded in the BitMint database to insure against potential hacking into the BitMint database. The purpose of the drop-dead practice is to handle an extreme case where the coin database is somehow compromised, and hackers steal coin identities which they later try to redeem. Since no unminted, (unissued) coins will be kept in the database, then eventually the minted coin will be submitted for redemption, and that is likely to clash with the redeemed hacked coin. If this clash will suggest that the database was hacked then the BitMint operator will dig manually (and laboriously) into the Drop-Dead storage, and identify which coin submitted for redemption is a result of compromise of the BitMint coin database.

That coin will not have the right identities for the drop-dead bits since they are kept only on the minted coin and in the drop-dead storage, not in the regular BitMint database.

### Mint Auxiliary Module:

The Mint Auxiliary Module will be comprised of:

software utilities

auxiliary database

The software utilities will include various cryptographic algorithms, traders' service software etc.

The auxiliary database will include:

traders database

validation hierarchy data

operational data

The traders database will feature a list of all the identified traders. Totally Anonymous traders will be so identified. Semi-anonymous traders will be identified, and their behavior and trading data will be accumulated without BitMint knowing their true identity. Eponymous traders will listed with all the relevant data known about them.

Semi anonymous traders and eponymous traders will be trust attributed, namely, based on their trading history with BitMint, and based on their account status with BitMint traders' bank, traders will be associated with a trustworthiness index that would signal to people who trade with them how trustworthy they are, and whether it is absolutely necessary for each coin they pay to be instantly validated or not.

Validation Hierarchy Technology:

The validation hierarchy is a hierarchy of BitMint nodes, extending from the BitMint itself (known also as the root of the hierarchy). Each BitMint hierarchy node (“node”) is comprised of:

Node Controller

Node Database

Node financial component

Node interface

Points of Design:

The coin data cascade

The validation anticipation procedure

Tree Configuration

The redemption sphere

The definite validation torch

The Coin Data Cascade:

The Purpose and Principles of the Validation Hierarchy

The Validation Hierarchy, VH, is motivated by the bottleneck vulnerability of a singular BitMint center tasked with validation of each transacted, or checked BitMint coin for every transaction, everywhere, at all times. The VH spreads this great responsibility over a collection of BitMint nodes. These nodes are structured as a hierarchy, where the root is the highest node, and they are counted from that place down. Each node, except the root, has a parent node, and some nodes have children nodes below them.

Ideally a VH comprised of n nodes will relief the validation bottleneck at a ratio of n:1. Each node will have, on average, 1/n validation instances to handle, compared to the work load of the single BitMint mint.

To the extent that the BitMint system will correctly anticipate the node that would be approached by a given trader to check or redeem a certain coin, it would be possible to provide that node with the validation data for the about to be redeemed coin, while denying the same from other nodes. Yet one has to provide for the situation where the anticipation is not correct, and a given trader approaches another node to redeem his coin. If the approached node has only data from other coins, it will have to keep the inquirer in limbo, since that node is clueless about that coin. Since this is not an operational option, the approached node will have to ‘shop around’ through other nodes to find which one has the coin data, or alternatively delegate the issue to the root—the main BitMint mint, which has data from all the minted coins, and based on the reply from root, to properly handle its inquirer. Either way such instances involve a run around that reduces the efficiency and speed of the money redemption process (compared to the ideal 1/n of the time to do alone).

If, on the other hand, all the nodes will hold the complete coin database, and hence will each be able to validate whichever coin is presented to it, then one should be worried about fraud where a trader redeems the same coin in two separate nodes. This concern may be handled through the concept of the validation torch. For each coin, at every moment, one node only will be regarded as the conclusive validator (CV), namely the “torch holder”, while all their other nodes are to be regarded as non-conclusive validators (NCV) or as validation disqualifiers (VD)—nodes that are clueless whether a presented coin is valid or not. The VH will try to employ an effective anticipation algorithm where the node that is actually approached for each coin, will be the torch holder for that coin. This will eliminate the waste of process associated with roaming around the hierarchy to find which is the torch node in that case.

The anticipation algorithm above will also apply to redeemed coins which are subject to a validation challenge. This means that one would try to equip each node with data of not only the coins that are ready to be redeemed by it, but also with data regarding each redeemed coin that is likely to be tested, or be subject to validation attempt post redemption. The latter case is a bit easier, since if a coin has been redeemed and node A knows about it, then if the same coin is submitted for a second redemption, before node A, it does not have to look for any torch node—it will reject the validation attempt forthwith.

The more nodes in the system the greater the security risk. Clearly the integrity of the BitMint operation is hinged on the integrity of its coin database. If that database is duplicated, in whole or in part n-times, then it is n-time less secure.

Disseminating the coin data to n node entities, which in reality are comprised of some organizational units with all sorts of people, also increases the risk for insider job of fraud and betrayal. Especially so if the node organizations (the people, companies responsible for each node) are distinct entities bound only by performance contract to the BitMint organization. This double edged security risk is herewith handled via the cascade principle, accordingly each node in the hierarchy will pass on to its children nodes enough data regarding the identities of conveyed coins, so that these coins can be validated by such nodes, yet, not enough data for same node to abuse that information in either an insider fraud, or when broken into by some external fraudster.

### The Hierarchy Node:

Each BitMint hierarchy node (“node”) is comprised of:

Node Controller

Node Database System

Node financial component

Node interface

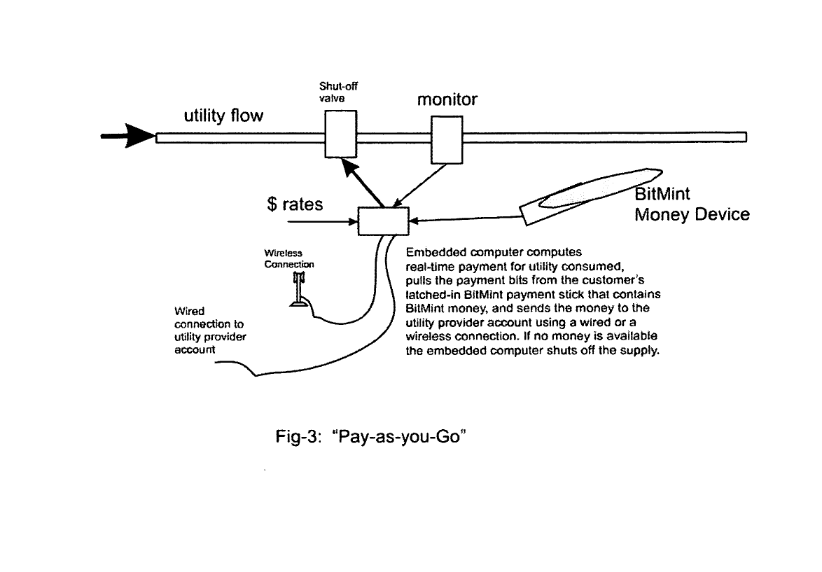

The Node Controller manages operation, and the other modules. The Node database accommodates the node coin database based on which the node database system evaluates the validity of each coin presented to it. The Node financial component handles redemption of valid claimed coins. The Node interface handles the communication with the traders as well as inter-node communication. (See FIG. 2).

### Validation Hierarchy Features:

Points of Design:

The coin data cascade

The Validation Hierarchy Procedure of Validation

Tree Configuration

The redemption sphere

The definite validation torch

The Coin Data Cascade:

A BitMint coin is comprised of n value bits. Traders redeem their coin by presenting them to a node in the BitMint cascade. Each node, is aware of a fraction of the bits, and unaware of the identity of the rest. This protects all parent nodes, and all sibling nodes from being defrauded by that node, or by individuals aware of the knowledge of that node. The reason being that anyone aware of that node knowledge does not have the knowledge of the missing value bits for that node, and thus cannot likely guess the identity of all the bits in the coin. It is important that the bit awareness of a certain node, does not indicate what bits are known to a sibling node, and what bits are known to the parent node. If this knowledge is available then a node (or people thereto) will have to guess right only the bits that a parent node or a sibling node knows, and not the bits of that those nodes don't know (those bits they could guess any which way because the paying node does not know their identity). It is therefore that a given hierarchy node, H, if aware of h<n bits of the value bits of the coin, where these h are randomly (or pseudo randomly) distributed among the n, then any child node Hc, will be made aware of the identity of c<h<n value bits of the coin. These c bits will be randomly distributed among the h bits known to the parent node H. The numbers of h and c will have to be selected such that for any two children nodes Cᵢ and Cⱼ the respective identity aware bits cᵢ and cⱼ will be sufficiently different (both bit groups were selected randomly). And of course, the number of identity-aware bit c=|cᵢ|=|cⱼ| will be sufficiently high to disallow any non-negligible chance to correctly guess their identity.

As long as the identity aware bits of a give node are numerous enough, that coin may project into its own children nodes.

The purpose of this cascade is to reduce the validation duty from the single root to a full fledged hierarchy. At any given point of time let there be m BitMint coins minted and circulating. In theory the root could use the procedure described above and communicate to each node the partial bit identity of all the outstanding coin. This is expected to be very cumbersome and unnecessary. Based on the nature, the size, and the purchaser of each of these outstanding m coins, one would be able to venture a guess as to how and where that coin is going to be used, paid, redeemed. So the root, parenting r children R₁, R₂ , , , Rᵣ, will assign each “child” information regarding a subset of m: m₁, m₂, . . . mᵣ. where:

0≦mᵢ≦m for i=1, 2, . . . r

Any trader will have the freedom to approach either the root or its r children to redeem any coin in his or her possession. We call “hit” the case when a trader approached a node to redeem a coin of which the node was aware, and a “miss” otherwise. The hit to miss ratio can be evaluated over any time frame, t, and the results may guide a special coin distribution algorithm to constantly improve the hit to miss ratio.

The Validation Hierarchy Procedure of Validation

If a coin is submitted for redemption to a node that does not find that coin in its database, then the node will pass the request upwards to its parent node. If the parent node finds this coin in its database, then there are two possibilities: either the coin is redeemable “on duplication risk” meaning, BitMint will take the risk of duplication fraud, because the coin is fully tracked, or because the redeemer is in good standing, or that node is the “torch holder” for that coin. In either case it would validate the coin to its child node, and the child node will validate and redeem the coin to the submitting trader. If, the coin is found in the parent node database, and that parent node is not the torch holder for that coin, then the parent node will start a ‘search for the torch holder’ procedure, and get the validation decision from there. If the parent node does not have the coin in its database, it would prompt its parent, and so on until the root makes the final determination whether the coin is valid, and redeemable.

Tree Configuration

The larger the tree, the greater the management burden, and the greater the chance for overwork to validate mis-estimated coins. But tree configuration should follow the actual trade dynamics. Nodes that are rarely approached should be cancelled. Nodes that are very busy should give birth to more children nodes, and so the tree will evolve adaptively.

The Redemption Sphere

It is expected that localized nodes associated with busy shopping centers will provide extensive payment convenience by assuming ‘torch’ status for BitMint coins that are likely to be spent in the shopping center. When a trader gets into the center, his money device (e.g. Smartphone) will communicate wirelessly with the center's local BitMint hierarchy node. They will agree on a sum that the trader is likely to spend in this trip to the center, say, $300, and BitMint coins for that value will be identified (per their coin id) to the node. The node might have ‘torch status’ for some of these coins, perhaps from an earlier trip. For the other coins the node will ask for ‘torch holder’ status by communicating these coin ids to its parent. The parent node will communicate to its parent, if necessary. This way, or by any other way, the torch holder for that coin will be found (it may be the root), and the torch will pass to the localized node at the shopping center. Once that node is the torch holder, then whatever payment, up to that sum ($300) made by the trader, the validation, and approval to the merchant will be done instantly and locally. The net effect is to spend time before the purchase so that once the trader made the purchase, then the validation and the payment approval happens instantly fast.

The Validation Torch:

Any coin may be known and held in the database of many BitMint hierarchy nodes. But only one such node is the torch at any given time. The torch holder status always begins with the root, but it may be passed from the root to any node as needed. The torch holding status means that that node is the only one which can finalize a validation and redemption of a coin. The idea is to prevent fraudsters from redeeming a coin twice at two distant nodes. Now this procedure may be relaxed as experience indicates. For small coins one might take the risk for double redemption, and allow a non-torch to validate and redeem. Same for coins with a full and complete track record, and also for traders of high mark of trustworthiness.

### The Coin Data Cascade:

The principle of the cascade is that a node is conveying to a child node coin data that is less than the data held by the giving node. The reduced data is still sufficient for validation of a submitted coin, but not sufficient for abuse of that data through a fraudulent attempt to redeem the coin from the parent node, or from any other node cognizant of that coin.

Given a parent node, P, and its child node C, and given a money coin M defined via the identities of its m bits. We assume that these m identities are randomly picked. A redemption candidate for the coin will have to present the mint a list of these m identities to prove possession of the coin. We assume that the parent node P has in its possession the identity of p<=m of the m bits of the coin. The parent node P will now inform its child C of the identity of c<p bits of the coin. Hence there will be (p−c) bits that the child node C is not aware of their identity but the parent node P is so aware.

The coin data cascade principle dictates that (p−c) will not be so few bits that someone from the child node organization might guess their identity and successfully defraud the parent node that he is in possession of the coin. And also that c will not be so few bits that someone could defraud the child node by successfully guessing the identity of these c bits. These two requirement dictate a practical limit on how small the value of p can be. And since the maximum level of p is p=m, it figures that the size of the coin, m, dictates how many level are feasible in the coin cascade. As things plan out now, m is of sufficient size to allow a very deep hierarchy configuration.

So given a minimum amount of coins to be put in the validation hierarchy, m, one faces a design challenge how to set the number of bits (p−c) that their identity is not communicated from parent to child, in conjunction with how many levels the hierarchy would encompass.

Another design question is how to pick the (p−c) bit that their identity will be made obscure? Since the BitMint operation allows for coin splitting it is necessary to insure that the anti fraud situation (number of bits one will have to guess) will be satisfactory for the mint. Therefore it is desirous to spread the (p−c) bits for which identity is not communicated from parent node to child node, across the m bits of the coin. These will be referred to as the “ignorant bits”. The spreading may be done uniformly or randomly.

In the uniform way the (p−c) ignorant bits will be marked one every interval, I, where I is given as:

I=rounded(p/(p−c))

The ‘rounded’ function indicates rounding the value of I to the closest natural number. In the random assignment each of the p identified bit for the parent node will have the same chance to become an ignorant bit for the child node.

Comparing the Random and the Uniform Methods for Identifying Ignorant Bits:

The random selection will make it more obscure for the hackers to determine which bits of the coin they need to try to guess, and which they could offer any guess because the node they approach is clueless about them. Yet, the uniform method guarantees uniform interval between the ignorant bits.

An interesting question arises from the situation that a parent node might have several children nodes. Would each child get the same ignorant bits? This will put the sibling nodes in mutual risk, because an individual from one node could move to defraud the other node, knowing exactly the identity of the non-ignorant nodes of that approached node, and also knowing which bits the fraudster may fake and guess with impunity because the fraudster knows exactly what the sibling node knows about that coin.

So we conclude that it is not safe to give each child node the same ignorant bits. We can resolve this issue in both the uniform and the random selection methods. In the uniform way, we select the (p−c) ignorant bits as follows for the first child: bit 1, bit I+1, Bit 2I+1, . . . where I is the interval computed above. For the second child, in some order of children the assigned ignorant bits will be: 2, I+2, 2I+2, . . . and similarly for the n-th child, the ignorant bits will be n, I+n, 2I+n, 3I+n, . . . . For the random method one may rely on chance to insure that no two children nodes will have the same ignorant bits.

The random method bears another advantage: a fraudster raiding a child node will not know which of the ignorant nodes are known to the parent node he would try to defraud, and which are not. The orderly uniform way will make it easier to guess.

### The Validation Procedure (VH):

The Validation Procedure (VH) is the procedure that would apply the Validation Hierarchy (VH) to process requests regarding BitMint coins. Each such request involves authentication of a submitted coin. We have seen the coin cascade built so that each node in the VH informs its children nodes about a subset of the coins it is aware of, and for each such coin it provides some ignorant bits from the set of bits that it is aware of their identity. Given that configuration we must now answer the question of what happens when a random traders submits a random coin candidate for validation at a randomly selected VH node.

The Coin Candidate May be in One of the Following States:

a valid unredeemed coin

a valid already-redeemed coin

a counterfeit coin.

The approached node may be the torch-holder node, or not. It may be the root, or a leaf (a node with no children nodes), or a node which is a parent and not the root.

We analyze all these combinations. The simplest case is where the root is holding the torch, and it is the node which is approached for validation. In this case the root will consult its database, confirm the status of the coin (per the above options), and so communicate to the approaching trader.

Now we discuss the case as above where the trader approaches a random node in the VH. The node may or may not find the submitted coin in its database. If the coin is not in its database it may be a counterfeit, or it may be a valid coin, redeemed or not which the node is simply not aware of. In that case the node will keep the inquiring trader in a hold position while it passes the id (header) of the coin to its parent node. We call this conduct as the ‘coin absent procedure’ (CAP). The parent of the approach node will also activate CAP (coin absent procedure) if it too is unaware of the coin. It will hold the approaching child node on hold (which the child node keeps the inquiring trader on hold). By re-applying CAP the inquiry passes up to the next higher up node (the grandparent of the inquired node). This will continue until one of two situations occur: either some upper node will be aware of the coin, or the upward passing will end up at the root. In the latter case the root is either the torch node or not. If it is the torch then it passes the verdict back on the same node track that brought the inquiry to it. The authoritative reply goes down the tree from node to its child until the result arrives to the node that was approached by the trader. That node that conveys the result to the trader. If the coin is good, the approached node will redeem it, or replace it per the wish of the trader (coin replacement algorithm follows—see below. If it is a counterfeit, or an already redeemed coin, it will so notify the trader. If the root is not the torch node for the coin then it would start a downward path, notifying all its children that were made aware of that coin that it is being probed. We assume here that the root knows which of its children was made aware of that coin. This procedure that the root was using to pass to a child node that a valid coin is being probed will be called ‘downward probing’. Each of the root children that was probed with the ‘downward probing;’ procedure (DPP), is either the torch holder or not. If it is then it will conclude whether that coin is redeemable, or redeemed (it is clearly not a fake coin). it will then pass up its coin verdict. The node to which the node verdict was past up will do two things: (i) it will pass the verdict further up (unless it is the root), and it will pass the verdict to its other children-node to which the coin data was passed before. Each node that received a coin verdict from below will pass the verdict upward and downward to its children nodes. Each node that received verdict from above (from its parent node) will pass the verdict to any of its children that the coin data was past to before.

If a non-root node is aware of the status of the submitted coin, it behaves like it was the root towards all the nodes below it, while it passes the verdict (based on its own knowledge) upward, where each node that received the verdict is doing the same passing it upward, and downward to its children, unless it has already done so before with respect to same coin.

Of course, if the coin is a counterfeit only the root will know it for sure, and so the probing will have to continue to the root from whichever node it started.

If the approached node is aware of the coin having already been redeemed then it so notifies the probing trader. One would assume that that knowledge was already communicated upwards, or was received from above, so no further notification is required.

Special provisions are allowed for very old coins. Children nodes will be allowed to discard information about sufficiently old coins. If such coins are being probed then the approached node may directly approach the root which will be one node that keeps track of all coins, young or old, or otherwise exercise the upward-downward validation procedure as above.

### Optimizing the Validation Process:

The validation hierarchy may deteriorate the validation process or enhance it. The reference case is a collapsed tree, otherwise known as root-only tree. As mentioned this will create a vulnerable bottleneck for the entire BitMint operation.

We shall first describe the best and worst cases, and then realize how great the gap is between proper and improper management of the VH.

The Best Case:

There are t nodes (including the root) in the VH, and the coins are administered in such a way that each node is the torch node for the coin that a trader happens to submit to it for probing. In that case the p coins that were probed will be answered on the spot (assuming no counterfeits have been probed). The trader will be informed right away by the node that it approached that the coin he asked about is valid and good for trade, or already redeemed. The traders are happy because they concluded the validation right away without waiting at all. If the coin was redeemed, then its new status will be communicated upwards by the approached node, and each node that gets this status change will pass it on upwards to its parent and downward to all its children nodes that know about that coin. Any node that finds from its parent node of the change of status of a coin will pass it further to all its children that were notified about that coin earlier. So in the best case each coin is readily answered by some post answer ripple effects happen throughout the hierarchy. As mentioned if the coin is counterfeit, then the probing will proceed from the approached node to the root node before this can be authoritatively concluded. And then this conclusion will pass down to the approached node to pass to the trader. So in that case the trader will have to wait 2h steps where h is the depth of the node he or she approached for probing. Such wait should not be counted as negative because the probing trader tried to defraud the system and is not deserving special fast reply.

The Worst Case:

In the worst case for every probed coin the trader is probing a leaf node while the torch node is another leaf node for which the lowest common parent with the probed node is the root node. In that case, if the depth of the VH is h generations, (the root being generation zero), then according to the VH validation procedure described above the VH will have to process 4h steps before responding to the probing trader. This is because from the probed node the inquiry will have to pass up from parent to parent to the root, because none of the interim parents is the torch holder. Since the depth of the tree is h generations, and the probed node is a leaf, it figures that the trip upwards will take h steps. Once the root is involved, it realizes the state of the coin. Assuming the coin is not a counterfeit, the root will have to pass the questions downward through the child node that it made the torch, when it passed the torch. If that node is not the torch it will have to pass the torch to the node it passed the torch to. This trip will take h steps to the leaf node that was made the torch node. That node then will give the definitive answer, which will pass up to the root, and then from the root back the way it came and wider to the leaf node that the trader probed.

So while in the best case the trader waits for a single ‘step’ to receive its answer regarding the status of the coin, in the worst case he or she have to wait 4h steps, where h is the generational depth of the VH.

If the probed node is a fake then the validation procedure will stop with the root, that would so conclude and the wait time will be 2h steps only.

Assuming that the channel trader-node has a limited capacity we may assume a deteriorating response function as the number of inquiries, probes, per second on the VH increases. For every such monotonic rising function ƒ(p) where p′ is the rate of probes over the entire BitMint system, there will be a rate p′ such that for a greater rate the best case will be better than the collapsed tree, and there will be a larger rate of inquiries per second, p′ such that the average response time for coin validation will be faster even for the worst case situation in comparison to the collapsed tree. So for both cases there will be a critical communication load p′_{c} such that:

ƒ(p′_{c})=4hƒ(p′_{c}/n)

The conclusion is that the validation hierarchy, VH, will have to grow in size commensurate with its communication burden.

The next question is how to navigate towards the best case and away from the worst case. This navigation involves estimates and probabilities since one can only anticipate with probability the coming communication load. We deal with the following questions:
how to optimize tree configuration
how to optimize coin information across the hierarchy

Mint Compliance Technology:

The sensitivity of money is likely to encumber BitMint under a barrage of constraints and regulations, and BitMint will do what it takes to honor them all. This is likely to be concerned with (i) reporting, and (ii) redemption prohibitions. The Mint will be checking all its activities, and money redemption with the current body of regulations. If an applicable government authority decrees instant reporting of some financial situation, then this module will generate this report and send it off. If a particular trader will have to be barred from redemption of coins without a per case approval of the government, then such will be the case. In fighting money laundering the government might wish to track certain money and certain people. All this tracking will be carried out as decreed.

InterMint Technology:

The Intermint will be a network of bitmints. Some under the same umbrella only working off different reference currencies, and some working through the same or similar computational framework but under different business management. The idea is to let these mints collaborate, and allow a trader to approach a single mint and get satisfied with all its coins from all other mints in the Intermint.

In a way the requests for validation from the sister bitmints will be the same as such requests from individual traders.

Trading Technology. Categories: Online, off-line

BitMint coins are designed to seamlessly shift back and forth between off-line and on-line modes. Even the initial purchase, and the final redemption can be either way.

A trader can pay online and have his or her BitMint coin downloaded for use. Alternatively a trader would be able to walk into any outlet where physical BitMint coins are for sale and buy any either with a credit card, or anonymously with cash.

A trader could use any of the available means to transfer the BitMint coin bits to a physical medium, and trade by passing that physical coin. Same in the reverse—a trader could use any of the available means to read the BitMint coin bits from a physical medium to a computerized form. Traders could pass around physical coins, or send the BitMint coin bit sequence in any desired trade.

Trading technology also regards the question of the reference currency. There are several categories for reference currency:
minimum risk fiat currencies
rated risk fiat currencies
financial instruments
specialized valuables.

The reference currency is the value that the trader trades in order to receive the BitMint points. In the nominal form this is a fiat currency like dollars, or Euros. These currencies may be at a minimum risk where they are deposited in a bank with very good capital to equity ratio. They can be at a slightly higher risk by allowing BitMint to deposit the money in regular bank accounts where a more risky capital to equity prevails.

In a more sophisticated application BitMint will trade in treasury bills, stocks, or other financial instruments, still with no risk to BitMint, it will simply trade up and trade back minted bit coins against the deposited instruments.

Specialized valuables may be any commonly accepted items of values: like collaterized real estate combinations, a basket of fiat currencies, etc.

online trading technology: Categories:
Decision Trading

Arrangement Trading

A decision trading is one where the payer made a conscious decision to make the payment and participate in the transaction. The payer had the option to back off. In an arrangement trading, the payer and the payee enter into an agreement that spells out under which conditions a payment will happen, and when the conditions arise the payment comes to pass without a per-payment decision for it.

Online trading technology also allows a desired balance between anonymity and visibility.

### OnLine Decision Trading:

Trade conducted per positive decision of payer to pay for the transaction.

large scale trading

small scale trading

In large scale transactions one is more likely to validate the payment. Such transactions are more attractive to thieves so that more trader's security is called for. In small scale decision transactions, each payment can be verified, or can be accepted on trust.

We distinguish here the following payment configurations:
wallet-to-wallet
wallet-to-account
account-to-wallet
account-to-account

The wallet to wallet option takes money from one personal computer or personal device and moves it through the Internet to another similar device. There are no server based accounts involved, no banks, no cloud communication, just a point to point communication, like email. It may be that the wallet to wallet communication will go through the ‘clouds’ but only in an assistance capacity. The payer might upload the coin to a server, and provide the payee a way to access it there. The payment partners in that case will take care of their security. If they know each other they might have had a chance to exchange some agreed upon cryptographic keys, and use them in some trusted symmetric cipher. If the trading partners are strangers then they might use the continuity preserving ciphers like Diffie-Hellman, and Rivest, Shamir, Adelman, (RSA), and be responsible to their own security.

In the wallet-to-account and account-to-wallet options one party holds the money in a device and the other in the clouds. Payment can take place via email, or via web communication. Here too, the accounts can be privately held by each party, there is no need for a bank to be involved and be called upon to execute an actual payment, as the case is today.

Account to account payments will be typically taken up in a business to business mode, and the partied will worry about proper security.

It is important to re-emphasize that the accounts here are any files maintained by the partied. This is in a noted contrast to the prevailing money transfer today where only trusted, and well known banks and financial institutions can actually transfer money from one owner to another. And in fact no money is transferred. What is communicated is nothing more than instructions how to adjust the numeric values associated with the payer and payee accounts. Since today money is no object, but a number, it does not in fact pass on, except as instruction to the two relevant computers. But BitMint money ( [symbol] ) is actually a bit string that carries value and it is the string that is stored in the payer computer, it is the string that is communicated to the payee computer or device, or account and is stored there. The validity of the money is backed up by BitMint—wherever that money resides, and that is why it can reside anywhere.

### Bit Entrapment

Trading may be practiced with the payer flipping the sign of some randomly selected bits. The payee will not know which bits have been flipped. When the payee turns to pass the coin on, she would too flip the sign of some of the coins bits. And so on. If the coin is comprised of sufficient number of bits then this can continue for many traders.

This scheme, called bit entrapment may be used for (i) hierarchical use of money, and for (ii) tracing fraud.

A hierarchical authority may pay money to underlings who know that they would need to give back the money to the giver at some later time. This is assured because the recipients who have ‘contaminated’ coins (some bits therein flipped) cannot redeem them anywhere else.

On the other hand the bit entrapment can be used by having each payer flip some bits randomly. If a coin is stolen, or a holder double redeems, then it would be clear from which payer the coin was stolen from, provided that all the traders share with BitMint the identity of the bits they flipped.

Tit-for-Tat: BitMint will gradually relax the restrictions on infallible trade, like having only the node with the torch validate a coin, and then see if fraudsters act up. If they do, these restrictions will be tightened up, if not they will be relaxed.

### Arrangement Trading:

### Trade Conducted According to a Pre-Arrangement and Rules for Payment Agreed to by Payer and Payee.

Categories:

Usage driven

Time lapsed driven

Event driven

Usage Driven online trading is a situation where a payment is to be made per usage of some goods or services, usually in a real-time mode. Time lapsed payment is a special case of the usage driven case in which the resource paid for is time—usage time. In the event driven mode the payment is to be made upon the occurrence of an agreed upon event.

Arrangement driven often involve micropayments for which the BitMint money is uniquely adept.

The BitMint advantage for arrangement payment is that it voids the need for subsequent invoices, debts, collection, etc.

### Usage Driven Payment Technology:

Usage Driven online trading is a situation where a payment is to be made per usage of some goods or services, usually in a real-time mode.

Examples of usage driven payment is the consumption of a utility like electric power, gas, or steam. These utilities are hooked to the premises with a monitor that measures consumption. The measurement leads to embedded computation of cost to the user, and that running cost is being paid real time from an electronic device that keeps the user BitMint money.

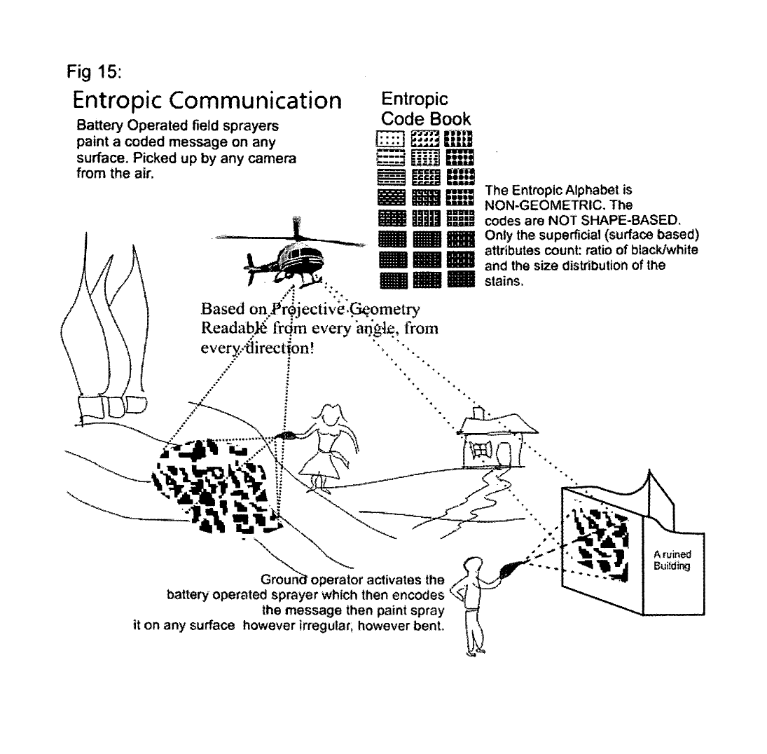

The payment device may be programmed to shut down once the money device is empty. See FIG. 34343-1

### Paid Time Technology:

This payment situation is a special case of usage driven payment in which the resource that one pays for is time.

The components of the set-up are very similar to the ones depicted for usage-driven payment, only that instead of the utility consumption one measures the lapsed time. In some situations the set-up will discontinue the paid service, in others such will not be possible, and a debt will be recorded. An example for the first case is payment for watching movies. The movie flow will disconnect when the money-stick is empty. An example for the second case is parking meter. If a car is parked but its money stick emptied, the car remains parked and a debt begins the accumulate.

### Event-Driven Payment:

Applies when a payment happens upon a pre specified event, and not before or after. For example a toll-road device that bleeds money to the road operator only if the vehicle is using that road, or bridge.

In such cases the system will include a sensor designed to notice the agreed upon payment event, and when a positive feed is supplied to the embedded computer, the computer computes the payment based on the agreed upon parameters, and ‘bleeds’ the customer device the correct sum. For some events the lack of money in the BitMint money device will allow the event controller to stop the event, in others a debt will be generated.

A particular case for event driven payment is when a trader wishes to buy BitMint money anonymously, and pay with a cashier check sent in the mail, or a similar situation. In that case BitMint will send the trader the coin, but its value will be event driven where the event is the receipt of the sum of the coin in fiat currency in good order. So the money will be in the hands of the trader—but useless. Alas, reading the coin id, and other identifying information the trader will be able to send a cashier check for the proper amount, marking on it, the coin id, and then wait for his BitMint coin to activate.

### Anonymity-Visibility Trading Balance:

The BitMint money and payment set-up allows traders to effect their desired balance between anonymity and visibility. We discuss the subject per:

BitMint-trader anonymity-visibility balance

trader-trader anonymity-visibility balance

money track record

The BitMint may exchange its bits for the fiat currency with a completely anonymous trader, or with a trader that is partially identified and known, or with a trader who is fully known to the mint. And the same for redemption. A trader too may pay or get paid to and from a stranger, or to and from a partially known trader. Also, the traded coin may be traded with obscure history, with partial history or with complete history.

### Anonymity-Visibility Balance:

We Discuss:

BitMint-trader anonymity-visibility management

trader-trader anonymity-visibility management.

In all cases BitMint is fully visible, clear, and totally un-anonymous. The traders may be anonymous, or totally visible, or, alternatively partially visible. The coin in both cases may be exposed with all its market history, or may be blind to it.

### BitMint-Trader Anonymity-Visibility Management:

The anonymity-visibility question may be relate to the (i) minting of a coin, and to (ii) the redemption of a coin.

Minting Anonymity:

The trader may keep himself or herself anonymous. As long as he or she pays the required fiat currency, he or she will receive the measured BitMint coin, and use it as he or she sees fit. To achieve this anonymity the trader will have to give up the convenience of using a regular credit card. Alas, he or she could use a pre-paid anonymous card to buy a BitMint coin anonymously online.

Another method is to use the paid by arrangement option, using the event driven payment. This method designated as Delayed Activation is comprised of (i) the BitMint sending to the anonymous trader his requested coin where the header indicates that the coin will be activated upon the eventual event of being paid for. Any attempt to use or redeem this coin before it is being paid for will be unsuccessful. The anonymous trader will send a cashier check to BitMint indicating on the check the coin id. As the check clears, BitMint will activate the coin. That way BitMint is totally in the dark as to the identity of trader.

Delivering the delayed activation coin to the anonymous trader may harm the trader's anonymity, and so special ways may be devised to doing so. One method will be for the trader to send to BitMint his public key. BitMint will use this public key to encrypt the coin, and then publish the encrypted coin on a public website with large access record. The anonymous trader being one of many who access this web page will not be identifiable. After downloading the page to his computer, the trader would identify the part of the page that contains his coin (based perhaps on some headlines on that page). He would them decrypt it using his private key and thus get a hold of the coin without giving the authorities or his pursuers a chance to identify him or her. Anonymous trading may also come to pass in the offline mode. BitMint will issue pre-minted physical coins to be sold in stores. The trader will be able to walk to the store and buy these coins for cash (fiat currency).

Anonymous trading BitMint-trader may encounter legal issues in different jurisdiction. Such obstacles are dealt with elsewhere. Here we only deal with the technology,

Alternatively the trader may have correspondence visibility only before BitMint. That means BitMint knows enough of the trader to be able to send him or her the coin, and bill him or her through credit card.

A more advanced level of visibility will be identified for self-security coins (the functional equivalent of travelers checks). Such coins redeemable only by their purchaser will require an agreed upon measure of identification of the purchaser-redeemer, so that hackers and fraudsters will not be able to violate the trader. The trader will have the option to surrender more and more private information to insure against such id fraud. All sorts of private secrets and parameters come into play, especially biometrics. A trader, for the sake of security, will give up the privacy of his biological makeup.

Redemption Anonymity:

Regardless of whether the minting was carried out anonymously, the redemption of a coin may be done with complete anonymity or complete visibility. The coin itself will carry the indication of its redemption anonymity requirements. If the coin allows anonymity redemption then BitMint will agree to do so upon validating the submitted coin. It will be up to the trader to indicate an acceptable anonymous payment mechanism. The common mechanism is the third-party payment in which the trader will indicate to BitMint to pay money to a third party. The ‘third party’ may be in cahoots with the trader, and pass on the money to him, or it may be a charity of some sort. This option is easily dispose towards illegality and BitMint will be very aware of it. Alas, traders don't need to insist on self redemption of a BitMint coin, they could simply use the coin as payment, and allow the payee of that coin to redeem it without the need for anonymity.

### Trader-Trader Anonymity-Visibility Management:

The anonymity-visibility options here are categorized as:

mutual anonymity

payer anonymity, payee visibility

payer visibility, payee anonymity

mutual visibility

coin history visibility.

Mutual Anonymity:

By employing any asymmetric cryptographic tool, any two strangers could use fake names, and create confidentiality without identification. They could use this confidentiality to exchange BitMint coins, and any digital goods securing complete mutual anonymity. And all the while securing confidentiality vis a vis any third party lurking somewhere on the insecure channel.

Payer Anonymity, Payee Visibility

Obviously this can be done as above with only the payee using public and private keys to maintain his or her anonymity. Alternatively the payer could send a physical coin to the payee, over the mail or by other arrangements. If the coin is paid against digital goods, such can be delivered using a public private set of keys. If the goods are not digital then a third-party option as above is possible.

Payer Visibility, Payee Anonymity

Like above, the payee could use a set of public private keys and keep himself or herself anonymous. If the coin is paid against non digital goods, these good can be sent with identifying the sender to the non-anonymous payer. The payee could also use the third party option as above.

Mutual Visibility

The mutual visibility mode has several options. The traders may simply know each other's basic information needed to trade, say some digital good, as well as BitMint money (e.g. email address). Or they may insist on one or more measures of identity verification. They may also insist on a Trader's Trust Certificate. This is a certificate issued by a trusted authority, which in many cases may be the BitMint itself or someone on its behalf, that identifies certain traders as trustworthy, especially for BitMint trade. This means that they are trusted to be involved with bona fide trade only, or for a higher level certificate, that they maintain an account of good standing and of threshold volume so that they can be made to account for any problem with bad coins that they by some disorder pass around.

In summary the mutual visibility options are:

communication address

identity verification options

trader's trust certificate

Identity Verification Options:

The full range of identity identification in the online world can be used to verify the identity of a trader. In addition a trader may identify himself as a bona-fide BitMint trader. BitMint might run a list of identified traders in good standing and at various degrees of trust. Each listed trader will be given a pair of public-private keys. All traders will be able to read the public key from the BitMint traders' list. So anyone wishing to ascertain the identity of his or her trading partner, will (i) ask for their name, and when given (ii) will read their public key from the BitMint bulletin board of traders, then (iii) compose a simply question (e.g. 6786+8345?), encrypt it with the public key read from the bulletin board of traders, and then (iv) check the answer. If the correct answer comes back then the identity verifier will be reasonably assured that his trading partner is in possession of the private key corresponding to the published public key, and hence that that partner is indeed who he or she says he or she is. Each trader might be certified as bona-fide and trustworthy, and even as holding an account of some volume, by any third party trust outfit that is in the business of issuing trust certificates written by the third party trust outfit (certificate authority) using the authority's private key, and being verified by their public key. In general any commonplace identity verification using or not using a third party certificate authority will be usable as identity proof for BitMint trading. Coin History Visibility A payee for his or her own reasons may insist on trading with full visibility coins, where not only the identity of the trading partner is verified, but the full history of the coin is on display.

### Money Track Record:

A traded coin might have changed hands several times since it was minted, and no central authority will have a track record of its history. That is the case with money traded today, especially off line. A recipient of a coin may know its payer, and thus will have one level history before the coin is his or hers. The payee may query the payer about who gave him that coin. This would be important if the payee trusts the payer, and in that case he would not have to validate a coin the payer asserts that he received it fresh from the mint. On the other extreme any coin might carry along its entire track record, and thereby identify all the traders that had possession of it since it was minted.

Given that fraudsters for their own interest would be interested in forging any track record history of the coin, it is necessary to provide cryptographic protection for the coin history. On the other hand such a track record will allow for profound insight as to how the money flows between the traders in society. Along with the ‘tethered’ attribute of digital money, the track record option brings profound novelty to financial systems.

We discuss below several cryptographic means to capture a BitMint coin track record:

The Per-Trade Validation Scheme

The Signature Dove-Tailing Scheme

Both schemes creates a growing ‘tail’ or ‘header’ that becomes part of the coin and identifies its transactional history.

Under both scheme a trader, say Bob, could ‘cheat’ by passing the coin to an unregistered trader, Harry. If Harry tries to redeem the coin—it is rejected because he is not registered. But if Harry passes the coin to Sam, and Samantha who eventually return the coin to Bob, who then transitions the coin to Carla—fully registered, then neither Carla, nor BitMint knows of that side trip conducted by the otherwise tracked coin. However, this is risky for Bob since, if the coin does not return to him, he loses the chance to redeem it.

If the coin is split, than each split coin is handled as if it were the entire coin.

### Per-Trade Validation Scheme:

In this scheme each payee submits the coin for validation. Alas, rather than receiving a brand new coin in exchange, the payee receives the same coin with a BitMint issued validation mark the identifies the identity of the payer and the payee. When the payee later, pays with this coin, the new payee submits it to BitMint for validation. The BitMint then checks if the new payer is the former payee. If there is no match then something is clearly wrong. Namely the coin has been transacted among one or more obscure traders. The question of what to do in such case is a question of users' policy.

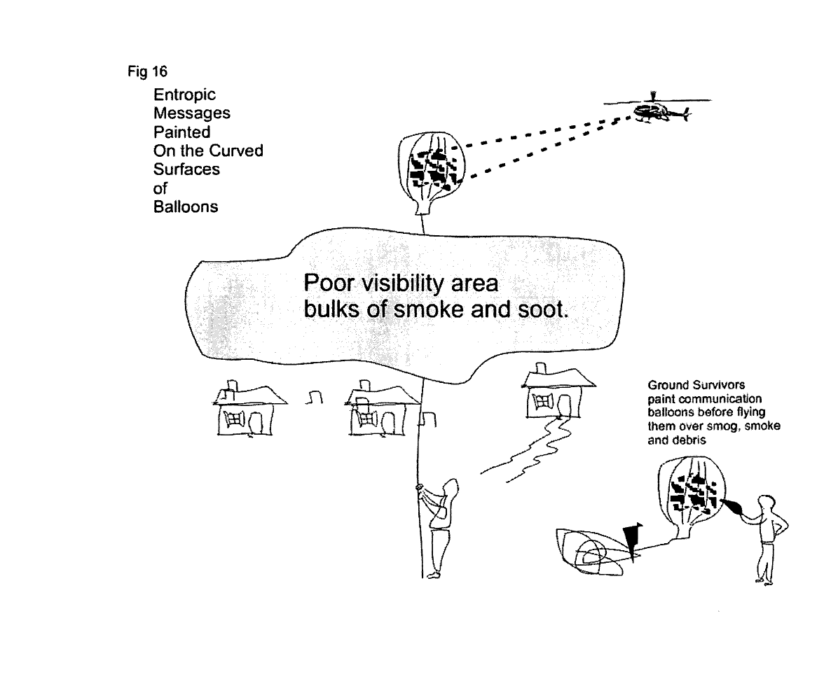

If all is well the coin carries the growing list of its bearers. This is cumbersome for the Mint but it does the job—captures the entire history of the coin. The BitMint uses its private key to sign these transaction records, and the traders will verify the statements using the BitMint public key. This tracking scheme is depicted in FIG. 343553. Explanation: Alice pays BitMint with fiat currency, (a), and receives in return a BitMint coin depicted with the BitMint icon ( [symbol] ) on its left to indicate the value carrying bits, and header comprised of a signed identification of Alice as the trader to whom the coin was dispatched, along with some meta data (T) regarding the transaction. This is indicated by the mark “A-T” of the coin. To the right of this marking BitMint stamped its symbol ( [symbol] ) to indicate that the trader's id statement (“A-T”) was signed with the BitMint private key, so that anyone can decipher it with the BitMint public key. The coin so marked is delivered to Alice (b). At some later point Alice trades with Bob as the arrow Alice-Bob indicates, and she wishes to pay Bob with that coin. Alice will so indicate and communicate the coin to BitMint (a′). BitMint will now add another statement: “B-T” indicating the new owner of the coin is now Bob, and “T” represents the meta data of the transaction Alice-Bob. That statement is also signed with BitMint private key, and then delivered to Bob (c). At a future date Bob trades with Carla (shown by the arrow Bob-Carla), and so he sends the coin to BitMint (d), and BitMint adds a new transactional statement “C-T” signed by its private key, and delivers the coin to Carla (c). When Carla wishes to pass the coin to David, she so indicates to BitMint (f), and BitMint adds the new transactional information to the coin and delivers it to David (g).

### Signature Dove-Tailing Scheme:

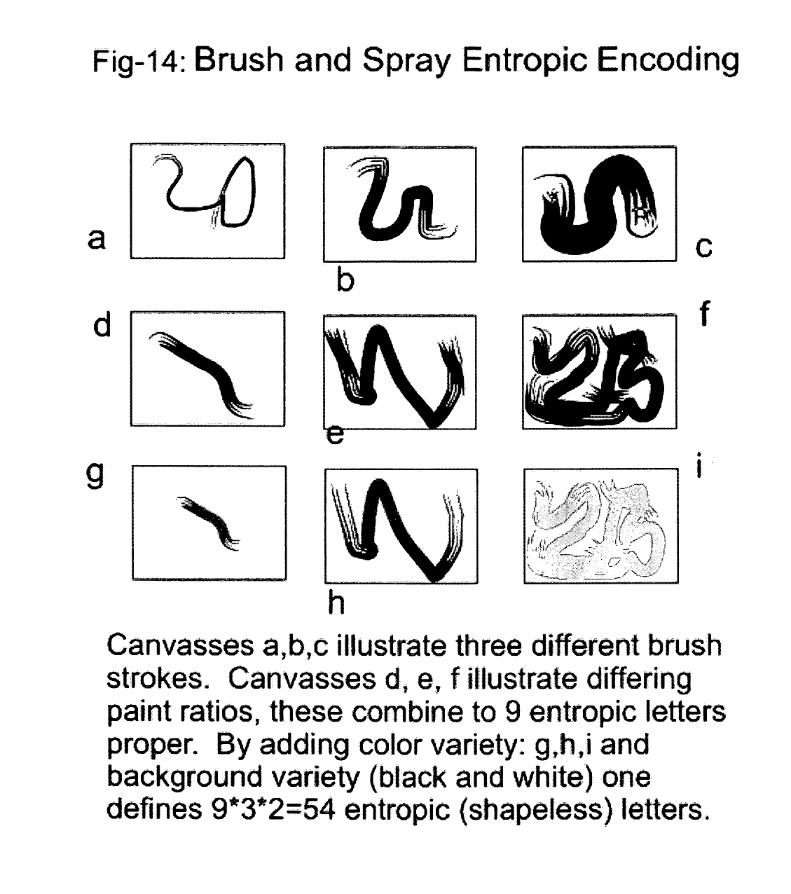

See FIG. 343353, explained: The figure shows the BitMint passing a coin to Alice who then passes it to Bob, who passes the same to Carla, who in turn passes the coin to David. The value part of the coin does not change throughout these payment actions, but the header part keeps growing. When BitMint passes the coin to Alice it uses its private key to sign a statement that identifies Alice as the recipient of the coin, along with some meta data, like the time stamp of the transaction. When Alice passes the coin to Bob she adds to the header a signed statement that identifies Bob as the new owner of the coin, along with meta data regarding the transaction. Alice uses her private key for the signing. A similar process takes place when Bob passes the coin to Carla, and when Carla repeats the same towards David.

Now, if David wishes to ascertain the history of the coin he just received, he uses Carla's public key (published perhaps by BitMint), and reads that Carla documented the fact that she passed the coin to him. But he can then verify that Carla received the coin from the registered former owner of it, Bob, because Bob identified her as the recipient of the coin. This proves to David that the coin did not make some ownership trips between Bob and Carla

Off-Line Trading Technology:

In the off-line universe we identify two modes of trades:

blind trading

open trading

where the distinction is that in ‘blind trading’ one does not expose the bits, one rather trusts the coin contains valid bits as declared.

### Open Trading Off-Line Technology:

There are Three Questions Here:

the coin medium (physical carrier)

coin readability

coin integrity

The physical readable BitMint coin may be comprised of any physical matter, including: paper, plastic, composite, metal, and the like.

The BitMint bits may be device-readable, and/or humanly readable. The coin may be written as a string of bits, or it may be coded in some alternative alphabet (e.g. base-64).

The coin may be easily forgeable, and in that case it would have to be traded against an immediate validation or on strong trust, or it may be tamper-resistant.

### Blind Trading Off-Line Technology:

In off-line blind trading, the BitMint coin takes a physical form with the following attributes:

The identities of the coin bits are concealed.

The coin physical form exudes trust that its bits have not been exposed

Along with the optional attribute:
The coin is ‘Destructive Reading’ type (bit contents is erased upon its reading).

### Bit-Blinding Technology (Offline Trading):

Bit-Blinding Technology may take the following forms:

Reading Intractability

Secure Enclosure

Destructive Reading

Reading intractability refers to the situation where the BitMint bits are encoded in a way that requires a special reading device to identify their identity. The ‘reader’ may be (i) an expensive device, (ii) a rare device with controlled distribution, and one that is hard to forge, or (iii) it must operate with the introduction of a cryptographic key, which is kept in secret.

Secure enclosure refers to the situation where the BitMint bits are written inside a ‘coin’, and their identity is protected with a secure enclosure that resists tampering, or that it opening is clearly visible to any coin holder. The secure enclosure can be released through a code that is sent to the coin holder from BitMint upon request.

The Destructive Reading coin is trusted on account of it not yet being readable, since had it been read (and the BitMint coin bits identity exposed), it would have been clearly visible on the coin. The virginity of the coin testifies to the fact that nobody exposed it yet.

### Reading Intractability Bit Blinding Technology:

Reading Intractability Technology Options:

Projected Radiation Technology

material contact reading.

The radiation based reading may be with either the coin or the reader being the source of the radiation, or even both. In the nominal setting the reader device will project a certain radiation on the coin, and read its bit contents by its response to that radiation.

One possible way is to examine the reaction to polarized light in order to read a sequence of chiral components that stack up a bit order.

Material contact reading may be based on a chemical or physical reaction between a ‘reading paint’ that is smeared on the surface of the coin, on which the bits are marked with otherwise invisible ink. The more unique the ‘reading paint’ the more difficult is it to a stray coin holder to read the contents of the coin.

### Secure Enclosures Bit Blinding Technology:

Secure Enclosure Technology Options:

Non-resealable enclosure

Triggered Erasure Enclosure

The non-resealable enclosure is a solution which makes it clear upon examination that the coin has been compromised because the enclosure that keeps inside the coin data was clearly compromised. Such will be a box, enclosure that must be split, cracked, or cut through in order to open it up. Such opening will make it unsealable, and hence an examiner of a pristine coin will be led to assume that the enclosure was never opened.

A triggered erasure enclosure is one where upon a fraudulent attempt to open it, the contents of the coin will be erased, and hence the coin will be void. A fraudulent attempt to open a coin is one that is not sanctioned, and guided by some opening instructions and information by BitMint.

Secure Enclosure Technologies May be:

Delayed Erasure type

Random pressure type

Random Gas content type

Delayed Erasure type are coin where upon opening them in any way, a clock starts ticking towards an event of bit identity erasure. During this countdown there is a chance to key in a preservation key that must be supplied by the Mint based on the coin holder identifying the coin id. If the preservation key is applied in time, the coin is preserved, otherwise its contents is being erased.

A random pressure type coin is one where the contents of the enclosure is filled with gas with at some pressure p. The compromiser might know the range for p (p-lowest to p-highest), but not the actual p, except that it is different (higher or lower) than atmospheric pressure. If the coin is opened in a hood or otherwise, a pressurized or vacuum environment that does not have an ambient pressure of p (but one higher or lower), then the pressure inside the coin will change, and that change will trigger an electronic circuitry that would erase the content of the coin. The Mint will supply the coin holder with the pressure p information for that coin, so that he can open the coin within an ambient pressure of p (same as the coin inside pressure), and hence there will be no change in the pressure inside the coin, and the contents of the coin will not be erased. A Random gas content type coin is one where the gas that fills up the coin is of random combination of quantities of various gases. The coin itself will be equipped with an internal radiation device, and a corresponding radiation reading (electromagnetic radiation). The specific contents of the coin gas combination will result in a specific radiation profile recorded by the radiation reader. Should the coin be opened in any way in an ambience where the gas combination is different than that of the inside of the coin, then the radiation reader within the coin will detect a change in the radiation absorption in one or many radiation spectrum. This change will cause the erasure of the coin's bit content. Upon passing to BitMint the coin id, BitMint will identify the environment in which to open the coin without erasure.

### Destructive Reading Technology:

Unlike the ‘content erasure’ option for secure enclosure blind bits technology, the destructive reading principle says that the act of reading the identity of BitMint bits will be clearly indicated upon examination of the coin. So that if such signs are not present then the chances are that the contents of the coin was not previously read.

Such can be Achieved Through any of the Following Technologies:

invisible ink

destructive radiation

Invisible ink may be revealed using heat or a reading chemical.

Destructive radiation may be based on the Compton effect—the interaction between projected electron and electromagnetic radiation.

Coin Technology

Categories:

Abstract coins

Physical Coins

Abstract Coins:

Abstract BitMint coins are comprised of a header, a body, and a trailer—all binary string. The trailer is optional. See Fig.

The BitMint coin header:

### BitMint Coin Header:

According to the alpha design the header is fixed size string featuring:

Mint id

Coin class

Coin id

Time Minted

Original Purchaser id

Code of Terms

Code of History

Split-Starting Bit

Splint-Ending Bit

Time Redeemed

Redeemer id

Each Mint will be identified to facilitate an InterMint—a set of communicating mints. The BitMint coins will be identified per class according to several parameters, like:

Pre-Paid or Paid-on-Demand (POD)

Reference Currency

currency-to-bit resolution

and other class markers per future development.

The coin-id will uniquely identify the coin. If the mint plans to mint n coins over its life time then it would require log(n) bits for the coin-id field. (e.g. a 64 bits coin-id, written as 4 hexadecimal characters, will cover 1.84*10¹⁹ coins). There is an advantage to assign the coin id randomly (a pseudo random number generator will do for that).

Time minted will be in a per second resolution, and marked per a running count from the moment the mint starts to operate.

Original Purchaser Id:

### The Body of the BitMint Coin:

The body of the BitMint coin is comprised of bits such their count reflects the value of the coin, per the indicated resolution of bits per reference currency.

The n bits that their count reflects the value of the coin will be called value bits. According to the alpha design a coin of n value bits will be described via 2(n+1) as follows:

Each value bit of “0” will be written as two bits “01”. Each value bit of “1” will be written as two bits “10”. Each value bit for which the value is not identified will be written as “00”. The body of the coin will be started, and ended with a “11” double-bit.

For example: if the value bits are: 10010011, then the alpha design will write the coin as:

11 10 01 01 10 01 01 10 10 11

And if the second and fifth bits are masked, the coin will be written as:

11 10 00 01 10 00 01 10 10 11

If that coin will split in half to one coin: 1001 and the other coin of 0011, then these two splits will be written as:

11 10 01 01 10 11

11 01 01 10 10 11

The header of the coin will identify the starting and finishing bit of each split per the original coin. This particular selection insures that the random nature of the bit identities will not be jeopardized, and any encryption thereto will still enjoy the “random plaintext” effect.

Physical coins: categories

Plain bit containers

Cryptographically processed coins

Physically secure coins

Chemical coins

### Chemical Coins:

Chemical coins, chemically coded coins, are coins where the bits are expressed as chemical structures, chemical bonds, or otherwise in association with chemical properties. The basic properties of chemical coins are:

Non-trivial “printing”

Easy ‘reading’

ruggedness

convenient handling

And a great preference for:
Bit erasure while reading.

Non-trivial reading is important against forgery. The use of chemical coins is expected to be strong as a cash replacement. For small amounts the payee might not have to validate the coin, but accept it on account of its chemical expression given how difficult it is for the uninitiated to mint a chemical coin.

important implementations of chemical coins are:

chain molecules

scaffolding molecules

painted coins

### Chain Molecules Coded Coins:

These are coins which are expressed through a chained molecule. Let m₁, m₂, . . . mₙ be n distinct molecular entities such that for all i,j=1, 2, . . . n; n is natural number greater than one, we have the following situation:

[R−mᵢ]+[mⱼ−R′]=>[R−mᵢ−mⱼ−R′]

where R, and R′ are molecular chains in the form:

mₖ₁−mₖ₂− . . . −mₖₜ

where t is any natural number, and k1, k2, . . . . kt=1, 2, . . . n then the set: {m}={m}ₙ=m₁, m₂, . . . mₙ will be regarded as a coin coding set.

In other words a set of molecules that can be strung together in any order and create a stable macro molecule thereto, will be in a position to serve as a media to code any BitMint coin. We further define the natural number N as the number satisfying:

log(n)−N<1

where log(n) is taken as logarithm on basis of 2, and then assign each possible binary number in the range: 00000 . . . 0 to 11111 . . . 1 (where the number of digits is N, so that for N=5 we regard the range 00000 to 11111), to a specific index i=1, 2, . . . n in a way that some k molecules, where:

k=n−2^{N}

will be either left unassigned, or be an alternative assignment to a given configuration of N binary digits of size N digits.

This set-up will allow for an n-size chemical coding set to be coded as a BitMint coin of r digits by synthesizing a chain molecule comprised of p molecular units from the set {m}, for any r value such that r=0 mod N, and such that the resulting molecule will be practical to handle. Minting such a coin will amount to synthesizing the set {m} in the proper sequence and the proper length, and validating, or reading such a coin will amount to reading the synthesized sequence.

We now review several implementation options for this chain-molecule coded coin.

protein coins

chiral coins

### Protein Coins:

We currently have the technology to synthesize an at will combination of the 20 common amino acids in biological systems, emulating nature synthesis of proteins. For n=20, N=4 (log(20)−4<1), and every coin of size 4k bits can be expressed as a “protein” of proper sequence (k=1, 2, . . . ). We also have the technology to read protein sequence so that a such a ‘protein coin’ can be both synthesized (minted), and read (validated).

### Chiral Coins:

For n=2, we may select any two enantiomers (isomers with optic distinction), m₁, and m₂, and synthesize them in an order that would express a particular binary string. We can then read the chiral sequence based on their optical activity, and hence any such set will serve as a basis for chiral coins.

One could use a coin set {m}ₙ for n>2 in which each any m, component (i=1, 2, . . . n) is either left-handed, or right-handed optically, and double code it: once by selecting the proper molecular unit (mᵢ), and second by selecting the properly enantiomer for that unit. So a given sequence will coded two ways.

### Scaffolding Molecules:

A large, macro molecule may have well ordered active sites where any atom or molecules of a set of n molecules {m}ₙ=m₁, m₂, . . . mₙ, for n>1 may be bonded may serve as chemical expression for bit money, and will be designated as a scaffolding coin.

A scaffolding coin can be based on a polymer comprised of n close by different monomers:

r₁=r−m₁,r₂=r−m₂,rₙ=r−mₙ

where the BitMint coding happens very much like in the nominal polymer setting, namely the BitMint coin is coded as:

rₖ₁−rₖ₂− . . . rₖₜ

where k1, k2, . . . kt are indices in the range: 1, 2, . . . n

As an example one could regard styrene is the monomer base where the hydrogen atom on the Benzene ring opposite to the ethylene group will be replaced with any of several options, say Cl or Br, or I (halogens), or any backbone organic group R1, R2, The replaceable element on the monomer is far from the ethylene group where the polymerization occur, and offers minimum disturbance for polymerization into a polystyrene-based polymer.

The coding might happen either straight—meaning each monomer out of the n will designate one or more bits, or in a marker mode in which only n−1 distinct monomers are used to code the BitMint coin, and the n-th monomer is used as a fence-marker. This will allow synthetic flexibility.

For example, to code a BitMint coin with the monomer based coding that reads:

X—Y—Z—X

where X,Y, and Z are monomers used in the synthesis, the straight method will have to synthesize the same sequence: X—Y—Z—X; but the marker mode coding might look like:

X—X—X—W—W—W—Y—Y—W—Z—Z—Z—Z—W—W—X—X

where W is another monomer which serves as a marker, accordingly the latter sequence reads the same as the one above it. In the fence-marker mode the synthesis may add any number of same atoms to the string, not necessarily insist on one.

### Painted Coins:

Painted coins are coins where some surface is treated with a chemical that marks symbols (binary or any other alphabet), and symbols are humanly visible and humanly readable, or they are technology readable. Upon reading, the fact of exposure may, or may not be evident, and the written coin may or may not be erased.

Applications

Categories:

Pre-Paid Money Exchange Applications

Paid on Demand (POD) Value Exchange Applications

Money Asset Management

Banking and Investment Applications:

Intermint Applications

Specialized Applications

In the ordinary scheme of things a trader exchanges a nominal amount of fiat money against a BitMint coin, and in that case this coin is redeemable for its nominal value (discounting any applicable service fees). In theory the BitMint coin does not have to be paid for in fiat money until such time when the coin is redeemed. Such coins are regarded as Paid-on-Demand: they are issued to parties that commit to pay for them when so demanded by BitMint, which in turn will issue such a demand no later than when same coin is submitted for redemption. These two categories of payments allow for distinct applications.

Pre-Paid Applications

The nominal way to receive BitMint coins is to pay for them with the reference currency. And then the BitMint money can be regarded as debtors notes, IOU notes that traders prefer to trade with rather than with the fiat currency that underlies them.

Basically any use of money can be also carried out with BitMint coins. We discuss the following broad categories;

Earned Money transactions

Un-Earned Money transactions.

Earned money is transferred to the payee against an equivalence of goods or services, and hence is the total asset of the payee to dispose of it as he sees fit. Unearned money is money that is paid totally or in part against an expectation for some well defined event that should happen in the future. The execution of this event is the completion of the transaction, the point where the payee can treat the money as totally earned. Until such time the money in exchange is justly to a certain part to be controlled by the payer, not the payee. With regular expression of money it is very hard for the payer to enforce any understanding on how the money should be used because anyone receiving this money will treat as any other money for which merchandize is sold. But with BitMint money it is possible to set any desired terms of payment or redemption of that money, and keep the control over the money where that control is due. This ability to create justice for unearned transactions will encourage and increase the funders of innovation, social justice, and other matters of unearned money.

Earned Money Transactions:

These transactions can be categorized as follows:

Payment Convenience

Storage Convenience

Anonymity Control

Micropayments

Security Minded Transactions

BitMint money is easy to pay both on and off line, and shifting between these modes. They are easy to store, allow for controlled anonymity, and are well disposed to various security options.

### Security Minded Transactions:

Categories:

Travelers' checks security

Payment confirmation security

Transaction Security

Money track Security

Physical redemption security

BitMint money can be tethered to its owner to provide security in the mode of traveler's checks. One could transact in a mode where a non-repudiation receipt is provided for the payment. One could transact in a mode where buyer and seller share a mistrust, and need mutual security vis a vis each other, and also one could insist on transacting with money that has arrived to one's hands following a comprehensive payment track. BitMint may mint physical coins that will need to be physically submitted for redemption.

### Travelers Checks Security:

This is money that a trader tethers to himself, herself or itself. Only the trader can redeem that money. Clearly such self-tethered money cannot be used for payment, it serves the cause of security. If the money is stolen or lost, the thief or finder cannot make use of it, and the trader, on the other hand can claim for a re-issue of the tethered sum. This is security mode offered by the familiar travelers' checks.

Implementation Issues:

off-line implementation

online implementation

The security minded trader may wish to insist that his self redeemable money will only be redeemed if he or she present himself or herself before an authorized establishment, produces an agreed upon instrument of self identification, including biometric factors if so desired, and only then will the self-redeemed money be released from the self-redemption constraint and become money for general use, whether BitMint or not.

In less stringent implementation, the trader will identify himself using an agreed upon key, or a private key corresponding to a released public key. The key may be used to encrypt any private parameters, or it may be used to answer any random question raised by BitMint. All the acceptable modes of online identification can be used for the purpose.

The more stringent off-line implementation will be probably used mainly for larger sums.

The contract of the self redemption money will spell out the responsibilities of the parties should a hacker outsmart the self redemption protection. For instance, if the trader's private key was compromised, then it is hardly the fault of BitMint.

### Payment Confirmation Security:

It is a common requirement to receive a receipt or confirmation of payment. This can be done either directly from the payee or from BitMint. Of course, if the traded coin is history-tracked then the payment confirmation is built-in.

Payee Confirmation

The payer of a BitMint coin may request the payee to send back a receipt. The receipt could spell out the amount paid, and for what, like a regular receipt does, but be signed by the payee private key to provide a measure of non repudiation. Any other measures common for the purpose of non repudiation may be employed as agreed upon between the traders.

BitMint Confirmation of Payment

For the BitMint to confirm a payment event, it will have to be involved. Furthermore, it will have to be aware of the identities of both payer and payee. The payment, in fact will be transacted via BitMint. The payer will notify BitMint of his intent to pass an amount certain to the payee, and identify the payee in a sufficient way. The payer will then sent BitMint the BitMint coin he wishes to pay with—using his private key or any measure of security suitable to him or her. BitMint will validate the coin, and then will send the same amount to the payee using any form of security chosen by the payee. BitMint will then send a receipt to the payer. Note that one advantage of this scheme is that both the payer and the payee communicate each with BitMint and each using his or her preferred security measures.

### Transaction Security:

Often times the traders share mutual mistrust. The payer is reluctant to pay before receiving the goods, and the payee is reluctant to send the goods over without getting paid first. Such mutual mistrust is common in trade, and often is resolved by paying half before the delivery and the other half after the delivery, or some other partition of the payment whole. This scheme reduces the maximum loss suffered by either trader.

BitMint allows for several modes of transaction security:

third party involvement

payment by parts

randomized digital goods

pay-use differentiation

Third Party Involvement

This is the online version of similar off line situations. A trusted third party collects the payment into an escrow account, and does not release it until the buyer signals that the goods or services were well received.

Payment by Parts:

A simple replica of the familiar pay some before and the rest after—mode.

Randomized Digital Goods:

Digital goods are divided to n parts, each encrypted with a different key, and delivered to the buyer. The buyer chooses randomly m<n parts, and the seller provides the decryption keys for these parts. This assures the buyer that he has the goods, only in an encrypted form, so he can make the payment, and expect the remaining decryption keys in return.

Pay-Use Differentiation:

The idea here is that the payer makes the payment contingent on some future event. The payee may validate the coin, but he can't use it until that designated event happens. The time lapse is designed for the payee to deliver the goods (digital or otherwise). The designated event may be a simple future time point, or it may be some sort of “OK” from the payer. The coin may be defined ‘in limbo’ if the payer refuses to OK the payment. In that case the payee cannot use the coin, but the payer cannot undo the payment, so both traders are excluded from making use of the coin. This impasse remains until it is being resolved by some settlement between the parties or by court order.

### Physical Redemption Security:

Traders may wish to have recourse to the familiar paper bills and coins where the physical medium is the essence of the coin. This can be done by BitMint minting physical coins, specifically designated to be redeemed in an authorized outfit against physical submission, and examination.

Such coins may have their bit identification in the open since if one copies the bits and tries to redeem the coin online, say, it would not work because the coin will be designated for physical redemption. Much as it is with today's coins and bills, the physical coin will have to be sufficiently difficult to forge compared to its value.

A physical coin may also be self-redeemed to increase security, or it may be set for anonymous trading, as today's bills and coins. One difference from today's bills and coins is that if a stash of BitMint physical coins is stolen, BitMint can instantly block and invalidate these coins.

### Payment Convenience:

Convenience Aspects:

coin split

offline-online switchover

online payment flexibility

use of ‘terms of payment’

A bit coin fits into any electronic storage and communication (transfer) facility providing considerable convenience. Payer may spell out their desire for the payment they make using the feature of tethered terms of payment.

### Coin Split:

BitMint coins can be split into small coins, up to a minimum limit. These split coins can be handled completely separately as if they were minted as independent coins.

The minimum split size is security limited. It will have to feature sufficient bits to make a coin identity guess infeasible. The actual value of the split coins will be determined by the set bit value.

### Online-Offline Switchover:

The BitMint money solution allows for an easy and rapid switchover between offline and online modes.

We Discuss:

online to offline switch

offline to online switch

Using their printers traders could use base-64, or barcode, one or two dimensional, in order to reduce a coin into a hard copy that would be traded as such. The hard copy will have eventually be scanned to electronic rendition in order to be redeemed, but until redemption it can be traded, stored, and gifted as hard copy. The reverse is equally easy, any scanner will do.

There is also the possibility to reduce a coin from electronic expression to a sophisticated physical coin, where a secure enclosure is used, or the coin is chemically encoded. This will require more sophisticated machinery, both for issuing these coins and for reading them back into electronic expression.

### Anonymity Control Applications:

Traders have a full spectrum of anonymity control both on and off line. BitMint coins can be purchased, traded and redeemed with complete anonymity. Traders may choose to breach this complete anonymity in part or in extended measure. Traders may assume a pseudo name, trade with controlled visibility under the pseudonym, and safeguard their true identity.

The prevailing authorities will have the power to revoke anonymity from any transaction or redemption that warrants suspicion.

Total purchase anonymity can be secured by buying BitMint coins for cash from any participating outlets. Online anonymity may be secured by buying event-controlled coins that are activated by BitMint once BitMint receives payment (say in the form of a cashier check) for them. Alternatively traders may pay by using an anonymous debit card, or cash card, and using any of the prevailing continuity-preserving cryptographic protocols (e.g. RSA, Diffie Hellman). In trade anonymity is preserved because the payee does not care who the payer is, as long as he or she can validate the payment via BitMint. All that the anonymous trader will have to provide is a channel to be receiving the good he pays for without compromising his identity.

A coin that allows anonymous redemption can be so processed by sending the coin to BitMint using any chosen name, and employing continuity preserving cryptography as above to receive in return a payment code (encrypted by the trader's public key) and directions to the outlet where upon presenting the code, the dollar (or other reference currency) value of the coin will be handed over for cash.

Traders could choose to register with a pseudonym at BitMint, and establish a trading history, and behavior patterns, exposed to BitMint and to whomever will share this pattern, but since the real identity of the trader is concealed, the trader can pull out from his current pseudo name identity, and establish a new one, without compromising his true identity.

### Storage Convenience:

Electronic money stores easily on any digital media. The costs are falling the sizes get miniaturized and with that the convenience. One could use a small digital media card to store millions of dollars. Physical coins, can be stored much as today's bills and coins are.

### Micropayments:

BitMint coins lend themselves very naturally to passing individual bits from payer to payee and as such effect a payment of as little measure as desired passed over a long period as required. This means that money linked to a computing-communication device may allow for payment per use time or payment per micro amount of goods and services. And all that with anonymity control.

Unearned Money Transactions:

Unearned money transactions are payable in conjunction with the ‘terms of payments’ that may be linked to any BitMint coin. We can divide them as follows:

per restricted disposition

per future compliance

per future events

per specific time frame

Regarding restricted disposition: Unearned money may be restricted by the payer as to who will be allowed to redeem it. And by specifying such restrictions into the BitMint coin (specifying to BitMint which restrictions to associate with the coin for which the payer pays off), the payer secures control over his money and guides the way it is spent by the payee. Since the payee receives this money not against goods or otherwise earning, it is only just that the generous payer will have the power to control what happens with his money. There are numerous ways to spell out the disposition restriction. The redeemer can be names by his personal identity, he can be named by his or her membership in an organization, to the redeemer can be specified as anyone except some subset of potential payees. The disposition restricted coin is worthless to anyone except the directed payees (redeemers). While in theory a trader could accept a restricted coin as payment, he or she would probably insist on favorable conditions because the payees then accepts the restrictions in the coin.

For example Alice pays Bob $200 in BitMint coin that restricts the disposition of the coin to office supplies. Bob may buy some wine from Carla, and wishes to pay her with that $200 coin. Carla checks the coin in her computer (the coin's header) and finds that the coin can only be redeemed by an office supplies store, which she is not. So she rejects the coin as payment. Bob then offers to pay Carla and addition of $30 in unrestricted BitMint coins, arguing that since Carla anyway buys office supplies at a rate of $200 a month, then she could use his restricted money instead of cash. This way Bob circumvents Alice's intent in paying him the money. while this is possible it makes money reallocation much more complicated for larger sums and for many people.

The disposition restriction option is extremely powerful for budgetary control in business, for securing work on a given project, for restricting government from shuffling around money that was raised for one purpose, and paying it for another purpose; it is useful in restricting trust money from being invested in high-risk ventures, etc. It encompasses a profound idea that the payer of unearned money should maintain her control over the money so paid because the payee has not yet earned the right to do with it what he likes.

Restricted disposition applies also to the growing realm of coupons, and loyalty money.

Using Unearned Money Per Future Compliance:

often a transaction has a time lag between the delivery of its goods and services vs. paying for it. By using the unearned money provision of BitMint, one could handle such situations very conveniently. Alice hires Bob to complete a job for her. She will pay him right away with money that will be in Bob's hands, and fully validated by BitMint, but still will remain unstable because it must be released for payment by Alice once she is satisfied with Bob's goods or services. The setup can be such that Alice cannot pull back the coin, once paid. She can only keep it unstable by Bob, holding back on her “OK to use” signal. So Alice and Bob are stuck—none can use the money. They will have to come to terms, on their own, or through a third party: an arbiter, or a judge. This arrangement will keep both Alice and Bob on pacified about the deal.

One powerful application of future compliance is the cascade payment. Alice pays Bob $1000 in BitMint money, for him to further dispose $200 to each of his four subordinates, and keep $200 for himself. That money remains unusable until the subordinates Ok for receipt of their share. The same can be cascaded down to however many levels one desires.

Per Future Events:

Money can be paid and remain frozen until some event outside the control of the payee should occur. This mechanism allows for money to be ready and usable in the event of some financial crisis. In general it gives the payer additional flexibility to control the use of his or he money.

Per Specific Time Frame

Payer can spread out the use of their money over time to insure the payee does not spend the money right away, and for a variety of other reasons. The payer will indicate to BitMint the exact window of time when a payment is redeemable. Also all the amenities listed for earned money generally apply also for unearned money.

### Loyalty Money:

Companies use a variety of non-standard tools and methods to induce or reward their customers with unearned money designed to increase their business with the payer. The idea is to pay a customer so that he or she will do more business with the payer and eventually make him more money that he spends on that unearned money.

Such, so called, loyalty money, may be expressed via disposition restricted BitMint coins, and thereby replace the non standard method used today. The advantage to the payer (the merchant) is that he does not have to manage the book keeping of the money so disposed, BitMint manages it for him.

Many applications for loyalty money will use the POD BitMint coins, but in other cases regular coins are in order. Every known method used today for loyalty money can be managed with an equivalent method using BitMint loyalty money methods. However, BitMint loyalty money allow for easy extension and flexibility of any such plan. For instance the acceptance of loyalty money may be readily increased to include more merchants, or readily restricted for a window of time, etc.

### Paid-on-Demand (POD) Applications

These are applications with coins that have not been paid for, only a commitment to pay on demand was given.

Such Applications Include:

Self-Paid Applications

Credit Extension Applications

Crisis Management Applications

Self-Paid Applications:

These are applications where the coin buyer is also the coin redeemer.

Credit Extension Applications:

The practice of extending credit to good risk and profiting from the interest may be conducted using POD BitMint coins.

Crisis Management Applications:

Applicable for instances where liquidity has dried out, and human affairs or trade and value cannot commence. In that case BitMint will develop and disseminate a working currency, payment for which will be settled at a later time. In all cases the trader could get issued a large amount of money, for which he will have to pay only for the redeemed portion.

Self-Paid Applications:

Self-Paid Applications:

These are applications where the coin buyer is also the coin redeemer. In that case the buyer and BitMint will only exchange fiat money pro form a, not any real exchange. Alas such a buyer would be able to convey that POD coin into some trading cycle, as long as at the end of the cycle the coin is in the hands of the buyer, and he either submits it for pro form a redemption, or discards it. For all the traders that transacted the coin before it was returned to the buyer that coin functioned as good money. These traders may or may not know that no fiat money was ever involved.

The entire market known as loyalty money market expressed as coupons, air-miles, visitation counts, etc. may be handled via such applications as described above. A merchant will buy, say 1000 $100 POD BitMint coins, and emails these coins, say, to prospects he wishes to secure as customers. Such a prospect may hand over the emailed coin in lieu of cash, and hence benefit from it as if it were real cash.

Credit-Extension Applications:

Credit Extension Applications:

The practice of extending credit to good risk and profiting from the interest may be conducted using POD BitMint coins.

We consider the following parties: the credit extender (the creditor), a party with cash at hand willing to extend it for interest profit; the credit customer (the debtor)—a party in need of present cash, willing to repay it with interest later; a merchant—willing and able to sign onto BitMint; and, of course, BitMint.

The procedure: the creditor buys from BitMint, say, $1,000,000 worth of POD coins. No fiat money was exchanged. The creditor then extends the debtor a credit line of $25,000 by giving him $25,000 worth of BitMint coins. The debtor then fancies a piece of merchandize valued at $1000, and he pays for it with his POD coins. The merchant. upon receipt of these coins, will contact BitMint to validate these coins before he releases his merchandise. BitMint upon receipt of the validation request, realizes that the submitted coin is a POD coin purchased by the creditor. So BitMint turns to the creditor with the demand. The creditor then pays BitMint, which in turn validates the coin to the merchant, or most likely redeems the coin to the merchant so he can release the merchandise to debtor.

This concludes the POD coin cycle, and the matter is done and finished with as far as BitMint is concerned. Now the creditor and the debtor have an outstanding payment obligation between them, but that is not the concern of BitMint. The creditor assumes some risk here for which he is compensated with the eventual interest. Of course, if the creditor is not paying for the POD coins, the BitMint declares the POD coin invalid, and the merchant rejects the debtor.

The mint does not assume any risk regarding the ability to pay on either party. But the creditor will worry whether the POD coin was perhaps stolen from the person to whom credit was extended. One way to handle this fear is to put the burden of preventing theft on the debtor. If he loses the coin, it would be like losing cash. On the other side, if the debtor finds out that a coin was stolen he notifies the creditor, who is notifying BitMint ahead of time, or alternatively just notes not to pay that POD coin, should it ever be submitted for redemption.

Another way to mitigate the creditor risk is to enable communication between creditor and debtor before the transaction is fully concluded. This communication could take place before the debtor deals with the merchant (saying, for instance: I am going into this mall to shop), during or anytime before the approval of the deal.

The debtor and the creditor may also engage in a cryptographic protocol to frustrate fraudsters. The debtor could either encrypt the coin or sign it with a private key known to the creditor. In both cases the creditor will validate the signing or encrypting before agreeing to pay for the POD and thereby avoid many instances of theft of a coin. The encryption or hashing key will have to include a time marker so that it would be different from case to case, not enabling a thief to use a pre encrypted stolen coin.

Crisis Management Applications:

There are numerous scenarios in which a society may find itself without currency to deal and transact with. In such cases it is important to mint and distribute money to jump start the society. BitMint will be in a position to issue crisis coins, which will become a trading currency throughout the crisis. when the crisis is over, the issued coins will be paid for by some fiat currency.

During the currency there will be no redemption of the crisis coins, they will be circulated as such.

Money Asset Management

The unmatched convenience offered by BitMint will pull traders to deal with BitMint more and more. BitMint will then offer the option of being a registered BitMint trader which will identify the trader to BitMint, and for which BitMint will be able to sum up, organize and manage all the money affairs that are visible to BitMint. This will include the self-redeemable funds, the payment history, and also any POD money that a third party extended to the trader, because such paid-on-demand money will be conveyed to the trader by the credit giver, and the trader will validate such money with BitMint. Acting on a specific request from the trader the cash BitMint will query the trader's state of affairs in all other bitmints, to provide the trader with a periodic report of his or her financial status, forecast, bottleneck points, and strategy outlook. This service will make it more attractive for the trader to transform more and more of his financial reality to the visibility and convenience of BitMint.

Applications for Managing One's Money Asset Might Include:

Credit-Debit Net-Worth Reports

Money Flow Reports

Forecasting, Money Strategy Applications

Banking and Investment Applications

It is an a-priori strategic decision for BitMint to remain pristine in its primary mission, and not inch, slide, or encroach on typical bank applications. All such banking oriented activities will be handled by the BitMint Primary Bank. In particular, all risk management activities, all credit management, and any financial instrument exchange. The BitMint Primary Bank will be the financial institution that deals with the banking universe, and the relevant authorities.

A second bank, distinct from the BitMint Primary Bank will be the BitMint Traders' Bank. This will be a bank institution where traders will be able to open a BitMint account to deposit their bits there, to be managed, paid and paid to.

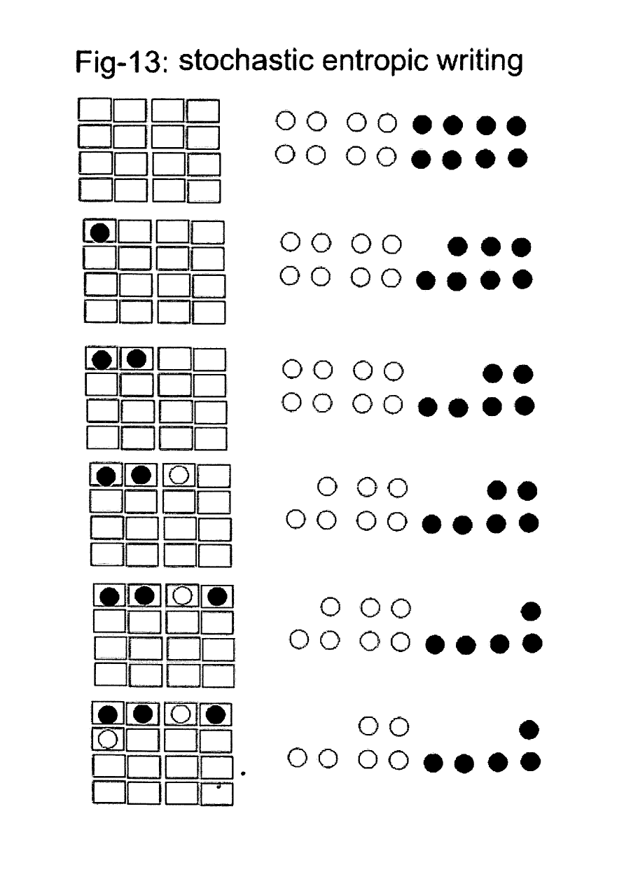

The overall BitMint banking environment involves the BitMint, the BitMint primary bank, the BitMint traders' bank, the community of BitMint traders, and the collection of financial institutions. See FIG. 56a. The BitMint traders approach the BitMint with a request for BitMint money (a). They pay a fiat currency for their BitMint order, using their various banks, or credit cards (b). When BitMint receives the money, it deposits it in the BitMint primary bank (c), and delivers the corresponding BitMint money to the traders who paid for it, (a). It is important to note that BitMint itself does not hold the money paid to it. All payments to BitMint go directly to the BitMint primary bank in a cash-like deposit, ready to be pulled out at any moment. The traders use the BitMint money to trade and pay. Some use their own computers and devices to store the money, but others prefer to open a BitMint money account. Alas, BitMint does not offer this service. In particular BitMint does not offer banking services. So the traders approach a third party: The BitMint Traders' bank. This bank accepts BitMint bits from traders, and open accounts for them (e). The accounts range for the full spectrum of common accounts. They can be saving accounts, or the equivalent of checking accounts, money markets, CDs, etc. The BitMint Traders' bank operates like any other bank only that instead of dealing with fiat currency in its government issued form, it deals with the IOU bills in the form of BitMint money. So a trader could use the Traders' bank to have easy access in the cloud for his account so he can pay and get paid from anywhere. Or a trader could deposit BitMint money in saving account, and the Traders' Bank will loan these bits to another trader. This other trader will be able to use the BitMint money he got in a form of a loan as if he purchased them directly from BitMint. When a trader wishes to redeem a BitMint money coin for any fiat currency he notifies BitMint (a), and BitMint, having validated the coin, is instructing the BitMint Primary Bank to pay the trader with fiat currency. The BitMint Primary Bank holds the full measure of fiat currency that the traders used to buy their BitMint bit money. It then negotiates and deals with the community of financial institutions to maximize its profits while remaining solvent and ready to pay off anything demanded of it by BitMint.

BitMint Primary Bank:

The BitMint primary bank is the bank that holds all the money paid to BitMint for its bit money. That money must be kept in payment readiness. The BitMint Primary Bank together with BitMint provide the necessary measure of trust to the traders. BitMint does not keep money, it passes it right along to the BitMint primary bank, and instructs the primary bank to make any payments upon redemption. This setup emphasizes the notion that BitMint per se is not a bank, and all it does is issuing debtors notes (IOUs) to its traders.

The BitMint primary bank will be responsible for the security of the deposits, and for their availability. The bank and BitMint will have to agree on the procedure that would guarantee to BitMint the on-demand payment for its traders.

BitMint Investment:

The basic BitMint as described here is a service designed to allow for trading and payment convenience, flexibility, and versatility. It is not an investment option. The money paid for the bits does not carry interest, alas, it also does not incur any risk except that the primary BitMint bank will default or the entire country will default. Traders, on their choosing will be able to buy BitMint as an investment, and hence sustain a well defined measure of risk. The risk associated with these investment BitMint money ( [symbol] i) will pass to the traders that will agree to receive such BitMint money as payment. This will lead to a trading sphere with risk-bearing investment-prone BitMint money.

It's important to note that any investment BitMint is a separate bitmint. The separate bitsmints may cooperate within a framework known as intermint, but operate each according to its own rules and regulations.
We describe ahead a few BitMint investment options:
   Interest bearing BitMint
   Bond And Stock market BitMint
   Collateral and Specialized valuables BitMint

An interest bearing mint will work like the cash mint (the basic BitMint) only that traders will be notified that (i) they will be collecting interest, and (ii) they will sustain a higher level of risk relative to the cash BitMint.

The interest mechanism is as follows: BitMint will deposit the traders' cash in a regular bank account under the well grounded statistical data regarding the dynamics of cash demands. That means that the bank will treat these deposits in a regular way, and be ready with only a fraction of the deposit for any random flux of demand for the cash. And hence the bank will be able to loan out the lion share of these deposits and collect premium interest for these loans. In return the bank will pay the depositors a smaller yet attractive interest. That payback interest will be shared between BitMint and the traders in some agreed upon way. So if Alice buys $1000 worth of BitMint coins and she keeps these coins in her computer for a year, say, then she will collect an agreed upon interest rate r that will be credited to her either in dollars or in BitMint money. So Alice will trade the extra security she will have in cash trading with some interest gains. If after, say, 6 months after buying these coins, Alice pays that coin to Bob, and Bob holds to the coin another 6 months before redeeming it, then both Alice and Bob will share the earned interest. If the coin was of the full tracking type then it is clear to the traders and to the mint how long each trader was holding on to the coin, and so distribute the interest equitably.

If the coin is not fully tracked then when Alice passes the coin to Bob she will notify BitMint of that fact, and demand from BitMint her interest share based on how long she held on to the bit money. Bob, on his part will readily realize the type of coin it is (identified clearly at the coin header), and he would notify BitMint of his possession, and then when he finally passes it on, or redeems it, to collect his interest. This can be done for large or small coins, but naturally the larger the sum the more worthwhile this bookkeeping. It is important to note that as far as the BitMint primary bank is concerned there is no difference between Alice holding the bits action less in her computer, or the bit being transacted each day between myriad of people. As long as no one claims the reference currency from the bank, the bank is ready to pay interest.

Bond and Stock Market BitMint:

Much as BitMint writes binary IOU notes (BitMint coins) against fiat currency, so it will do against any financial instrument, say stocks, bonds, or mutual funds. Like the cash BitMint, the stock BitMint will not be at any risk regardless of the value of the stock because it accepts stocks for safe keep, and issues a bit money that amounts to an obligation to return the received number of stocks. The returned stock may be of higher or lower value—that the profit or loss of the trader, not the mint. The trader who now own BitMint coins denominated or issued, or minted against a particular stock will be able to redeem the stocks at any moment, and in that respect he behaves like an ordinary investor. Alas, here the trader will have the extra flexibility to pay with the stock BitMint coin. This can be done in several ways. If the payee insists on fiat currency then the payer redeems his stocks, converts them to fiat currency according to their current value, and then pays the payee the agreed upon fiat currency, or, perhaps he buys from fiat currency type BitMint coins and delivers the BitMint coins to the payee. Another mode is for the payer to pay with the stock BitMint coins, at the equivalent amount to the agreed upon fiat currency payment, and the payee has then the choice to redeem the stock, or hold on to the stock. If the stock is considered popular and on the rise then it itself will turn into a popular trading currency, and payees will prefer to be paid with that stock rather than with cash.

The stock BitMint will not hold nor manage the stocks, but rather identify a primary brokerage to pass the traded financial instruments to. The primary brokerage will act in parallel to the BitMint primary bank.

Collateral and Specialized Valuables BitMint:

Much as a BitMint will mint bit coins against stocks and mutual funds, so it will issue bit coins against any item of acceptable value, especially such items that people like to hold and trade with, and so will be willing to be paid with bits that represent ownership in such valuables. There is no theoretical limit on what these bit-expressed valuables should be. They may be items of real estate, some art work, or anything else for which people are ready to pay.

Strategic Future of BitMint Money:

Taking the long view, BitMint may become a catalyst for future world economies and the global financial system. One can theorize that much as the original BitMint application is simply reflecting fiat currency, like Euro and Dollar and amounts to digitizing these currencies to allow for the BitMint advantages to come forth, so the same apparatus will be applicable to reflect any common valuable—fiat money or otherwise. A BitMint-Gold is perfectly doable, where traders will pay with Gold to receive tradeable BitMint-gold bit money. Same with respect to other precious metals. One can readily envision a BitMint bond market, or a BitMint mutual fund, or a BitMint specific stock apparatus where traders will pay with a given stock to receive that stock BitMint bits. One could envision an enterprise that owns a vast holding of real estate, currently estimated at $10 billion. The enterprise will express its full equity with a fixed number of BitMint bits, and sell those bits (bit money) per their rated value in dollars.

This proliferation of BitMint systems will allow the community of traders to vote with their financial decisions as to which backing they like more. It might be that, say, Americans will lose faith in the actions of the Federal Bank, and prefer to pay and get paid with bit-money that is backed by some real estate holdings, or by gold, or something else. All these “backings” will be tradeable with the ease here described—the ease of digital currency. This will allow the various backers of such bits to compete with each other.

The co-existence of various BitMint outfits will require an InterMint protocol. Given two backings of bit money: B1 and B2: if the exchange trade between B1 and B2 will be mostly done outside the BitMint systems then the exchange rate will also be determined outside the BitMint systems. And in that case the InterMint exchange protocol will daily reflect the exchange rate determined elsewhere. However, if the lion share of B1-B2 trade is carried out through the Intermint protocols then, the Intermint will act like a stock market and it will determine the exchange price B1-B2. These backing may be two fiat currencies, say B1= [symbol] , B2=$, or a currency v. gold, or gold v. any collateral instrument, etc.

Intermint Applications

While in theory the entire globe could be served with one global mint, it is probable that more than one mint will come into existence, and not all exact copies of each other. This state of affairs will require modes of communication between the mints in order to effect a global service.

We envision a network of mints, large and small, broad and narrow, representing same or different fiat currencies, common or special reference valuables, etc. The mints will be governed by a unifying protocol of cooperation and mutual respect. If the total trade in this “intermint” will be small then outside trade will determine the exchange rates between the various reference currencies for each participating BitMint. If the intermint trade will be of dominant volume then the exchange rates between the reference currencies will be set like in a stock market by supply and demand.

Ideally a trader could deal with one mint and use it to redeem all its bit-minted coins from each and any bitmint in the system. To effect this a simple cooperation protocol will be set forth. Accordingly the approached mint will validate and redeem its coins, and send the other bit minted coins each to the proper mint that minted it. The recipients mints will validate their own coins, and will send the redemption currency to the mint approached by the trader. En route from sending mint to receiving mint the money will have to pass through an exchange agency that will adjust the reference currency to the one used by the receiving currency. Finally all the reference currency assembled by the approached mint will be paid to the trader who submitted the various bitminted coins for redemption. it is important to note that the mint, in general, will only redeem money in its own reference currency or in other currencies for which it agreed to carry out redemption, at an agreed upon exchange rate.

The intermint dynamics is depicted in FIG. ______, Explanation: Trader Alice approaches BitMint-A with a collection of bitminted money minted in several mints (A, B, C, D). (a). BitMint-A validates its own bitminted coins, and sends the others to the corresponding mint identified on the coin header (b, c, d). The identified mints (B, C, D) validate their coins. If any coin of theirs fails the validation, that validating mint so notifies BitMint A (which Alice approached to begin with), and Alice conveys this rejection to Alice. Any validated coin is redeemed and the redemption money is either sent to the approached mint (BitMint-A), if BitMint-A accepts that currency, or otherwise the redemption money is sent to a currency exchange agent which converts the redemption money to a currency recognized by bitmint A. The gathered money are then passed along to Alice.

Specialized Applications

Several specialized applications of BitMint are discussed herein:

closed circuits

off-shoots

BitMinting BitMint (BitMint²)

Closed Circuits:

Any group of traders may take a lump of BitMint coins and in-trade with them, barring any payment outside the group. Such payment dynamics may be made invisible to BitMint and to anyone outside the group. To effect it one member of the group will buy a lump sum of coins, secured for only self redemption. That member will then distribute the coins of that lump sum among the members of the groups for ongoing payment dynamics. The payees in that case will not be able to validate the coins (since their redemption and validation is limited to the one to whom the coins were issued), they will have to trade on trust. At some point the member who bought the coins will submit them for redemption, and BitMint will not be the wiser as to whether this trade kept the coins in his computer, or used them to effect trade in a group, as he actually did.

Alternatively, the group will trade among themselves with complete visibility to BitMint, by simply designating the redemption rights to any member of the group, and not to others. Such group-assigned coins will be validatable by any group member, and money movements will be visible to BitMint.

Such group operations may have various usages. For example departments within an organization will wish to find out which is the more important more contributing department. So they would take a lump sum of ‘funny money’ issued by BitMint (may be paid on demand money so the money does not have to be paid for). The lump sum will be distributed evenly among various departments in the organization. The departments will then trade off paid services, using the ‘funny money’. The department that over time becomes the richest is the most contributing, most helpful one.

Private Games and Contests:

A group that wishes to hold a competition, a contest, or a game of some sort, playing for money will be able to maintain privacy of their activity using the ‘closed circuit’ concept. For example, the members of gaming group will give money to a representative who will buy BitMint coins for all the money deposited with him. The BitMint money will then be flowing back and forth within the group as the game or the contest dictate. By using good cryptography the players will be able to hide the data regarding their games, so that they will be potentially located across the globe. At the end of the games or the contest, the players submit the BitMint money to the same representative who will redeem the same total he deposited and distribute the proceeds according to the final holding of BitMint money.

Off-Shoots

Once the BitMint coins are on the market, then any third party can do with them what it wishes. A third party will be able to encapsulate such bits in a well trusted physical coin, and do business selling these coins. Others would offer effective coin transmission technologies, secure storage, etc.

BitMinting BitMint (BitMint²):

Much as BitMint works off its reference currency so one could activate a BitMint system off the BitMint coins. Namely a trader to this BitMint² will provide regular BitMint coins and receive BitMint² coins in return. Such operation will allow the second operation to create payment dynamics that is invisible to the first mint. This confidentiality might be of some value. Much as BitMint could operate without in principle receiving permission to do so from the custodians of the reference currency, so the BitMint² operation would be able to operate without consent of regard from the regular BitMint.

Reference Currency Creativity:

The BitMint system will work off any reference currency. This provides room for creativity. Some possible reference currencies are:

basket of national coins

Hedge funds, and risk-defined instruments

income generating assets

One could take one part Euro one part Dollar, and one part British Pound and define a coin basket (or use any other combination), and then construct a bit-mint off this basket, meaning that, say 90 bits will grant the trader the right to claim back 1 dollar, 2 Euro and 1 British pound. The market will determine if this reference currency is attractive or not.

Any financial instrument defined over a range of events and conditions will qualify as a creative reference currency, including real estate holding shares.

The reference currency could be any income-generating valuable. Like a package of mortgages and toll-roads, etc. The income would be paid to the traders in proportion to how long they hold the bit-mint coin. This will allow groups of investment specialists to design a combination of a valuable that would be traded the bitmint way.

Legality

Sovereign countries aware of the power of money, would insist on controlling their effective currency, and hence have an exacting set of laws and regulations designed to prevent any entity from taking hold of that power. It would be too easy for government officials, and regulators to confuse BitMint as such an entity, and unleash its full power to stop it. And so BitMint will have to be mindful of the strong possibility of misunderstanding of its doing, and be careful to abide by any prevailing laws and regulations.

It is important to stress that BitMint is not competing with any national (fiat) currency. To be correct BitMint does not mint dollars, or Euros. etc., BitMint mints binary-written IOU notes for sums in the fiat currency. The idea of BitMint is simply that for technological reasons it would be easier to trade with these IOU notes then with the fiat currency in its official form.

In the big scheme of things, it is the expected convenience and versatility of the BitMint solution that will create the pressure to adopt it, and run ahead with it. In our global economy such pressure will be global and prevail. But it will probably take longer than nominal estimates. One need to mind the following law categories: local law, state law, international law The BitMint system is committed to uphold all applicable laws and regulations.

### DEFINITIONS

Alice, Bob, Carla, David: Proverbial traders

bit-money: money expressed as an organized collection of binary bits {0; 1} without regard to the media in which it is expressed.

bitmint A societal organization minting, dispensing, exchanging, and transacting bit-money to express fiat money, and leverage it into novel societal benefits.

BitMint: A particular and specific bitmint, offering a comprehensive and global set of bit money services.

BitMint Application: A transaction involving BitMint coins in service of a well defined purpose.

BitMint Bill, BitMint Note, BitMint Promissory Note: Aliases to BitMint coin.

Money minted by BitMint using the BitMint Silver Minting process, and where the money string so minted is concatenated with a header string and a trailer bit strings by order: header-money string trailer, and where the header and the trailer contains data related to the money expressed in the money string (meta data), and where the trailer may be omitted. The attribute ‘Silver’ may be omitted, and understood by default. The coin may express any amount of money large or small.

BitMint Money: bit-money minted and transacted by a bitmint.

BitMint Silver Minting: A proprietary BitMint bitmoney minting process where the money is expressed via a bit string in which the number of bits in the string (string size) reflect the money value of the string.

BitMint Trader, Trader: A person, or an organization that is buying, selling or exchanging BitMint coins.

BitMint Wallet (“wallet”): A device, gadget, or any container physical or virtual that holds BitMint coins.

CashMint: An outlet on behalf of BitMint where only physical coins can be redeemed upon inspection for integrity.

Coin Exchange The act of invalidating a submitted coin, and delivering to the submitter a freshly minted coin of same face value.

Coin Extension: The act of BitMint delivering a freshly minted BitMint coin to a trader.

Coin Issuance: Coin Minting and Coin Extension together is referred to as Coin Issuance.

Coin Minting The process of BitMint issuing a BitMint coin at a specified fiat money face value.

Coin Redemption: The act of paying the face value of a coin in fiat money, and marking that coin is redeemed.

Coin Transaction: The act of delivering a BitMint coin from BitMint or from a trader to BitMint or to a trader. Coin extension is the first transaction for that coin.

Coin Validation: The act of examining a coin submitted for validation, and issuing a statement confirming or rejecting the validity of the submitted coin, where validity is understood as committing the validator to pay the coin face value in fiat money. The validating agency (the validator) is only BitMint, or anyone specifically appointed by BitMint to be granted the validation power.

Coin verification, Coin Approval: Aliases to coin validation.

fiat-money: Money declared by a competent government to be the legal tender in society.

Hacker, Fraudster, Thief: Individuals or organizations trying to abuse BitMint and its traders.

Ignorant Bits: coin value bits for which the identity is unknown.

Intermint: The network of interconnected mints trading with each other, allowing a trader to approach one of them and redeem coins from all of them.

Paid-on-Demand (POD) BitMint coin: BitMint coins minted and delivered (issued) against a commitment to pay upon demand its face value in fiat money.

Physical BitMint Wallet: A BitMint wallet comprised of a physical device, container of BitMint coins.

Pre-Paid BitMint coins: The regular BitMint coins for which their face value in fiat money was paid to BitMint before minting that coin.

Reference Currency: The currency that is expressed by the BitMint money. It may nominally be dollars, or Euros, but it may also be Gold, or other precious metal by weight, or any other accepted valuables, e.g. financial instruments.

Registered Traders: Traders that have registered with BitMint either with their real name or a pseudo name. They may be assigned a ‘trust index’ indicating how trustworthy they are based on their trading history, their holding in the traders' bank, etc. Traders registered with a pseudo name are referred to as semi-anonymous traders.

The BitMint Ecology: The BitMint System together with its traders, and transactions

The BitMint Primary Bank: A bona fide bank that is linked to BitMint, and takes on all the bank-like duties away from BitMint, so that BitMint can focus on its primary mission.

The BitMint System (The System): BitMint together with its global operations, including the validation hierarchy, procedures, rules, coins, and people.

The Coin Validation Hierarchy, (“The Validation Hierarchy”, VH): A hierarchy of organizational entities (nodes) where each node has a limited power to validate BitMint coins.

Value Bits: The bits in the BitMint coin that are part of the string that represents the value of the coin, and not its meta data.

Virtual BitMint Wallet: A BitMint wallet that keeps the coins electronically payment ready, and being-paid to ready, electronically.

### The Phone Age Innovation

The mobile phone becomes our point of contact with the world, the lever over technology of communication and interaction.

The functions of today's computer will be handled via the phone, rendering the computer and other large devices as operating under the control and management of the phone. Sensitive data will be captured and encrypted on the phone, and used from the phone either through cloud based applications or through phone to computer links, or phone to operating control board connections. This will require special security measures for the phone. We discuss: phone capabilities, Phone security, convenience extension

### Phone Capabilities

financial activity
entertainment activity
digital work
studies and learning
social activities

### Financial Activity of the Phone

The phone will communicate with the point of sale device of the merchant nearby, and through the network with far away merchants. The phone will house the money and pay the money. Any trust actions (approvals) will be carried out as much as possible with anticipatory software to avoid the approval bottleneck.

### Entertainment Activity

the phone will wireless communicate its stored much and video to stand apart devices.

### Digital Work

The phone will operate with convenience keyboards and mouse and convenience display devices, allowing one to work write, read, review, interact.

### Studies and Learning & Video and Audio Files, Graphics, Camera to Camera Exchange and View

### Social Activities

Notification of proximity (physical) or friends, free time signaling to chat with other free now friends. creating a shared ambience for intimacy with friends: listening to same music and background sound, as if both are sharing a cafe table, or sitting on the same beach. activating scent centers to share. The centers will house various scents and will be activated wirelessly by the phone.

### Phone Financial Activities

We discuss: payment and asset holder.

### Phone Convenience Extension

options: display, operation, carry around.
Display

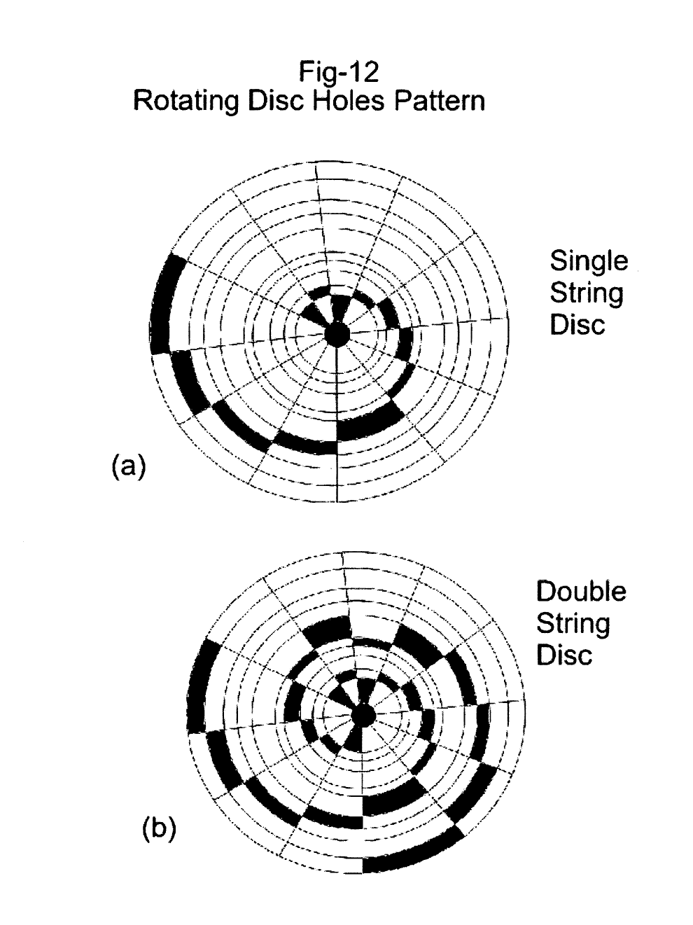

Phone will be extended with goggles that build an image like off-glasses, for large screen display. one would be able to carry along a display board that would wirelessly be hooked into the phone for display. The phone will unfold to offer a larger display. See FIG. 40. A phone screen (a) is expanded 3× (b) and 9×, (d).

The phone image will also project on any white surface like walls.

### Operation

operational buttons will be physically fitted on the back of the phone where an experienced hand will play them by memory of location, and a less experienced hand will watch an image of the buttons on the upfront screen. Each bottom will visually indicate whether it is being touched or not.

virtual keyboard will be touched through gloves with sensors that would project the image of the various fingers on the image of the various keys on the keyboard. Otherwise, folding keyboards, wirelessly connected will be used.

voice recognition voice command will be used to operate the phone.

wireless mouse will become an optional add-on device.

### Carry Around Options for the Phone

When immediate access not needed the phone will be stowed at one's shoe, so not to lose it. insole insert.

there will be malleable plastic phones, as well as elastic phones to fit to curves of the body, and minimize burden on pockets.

Welcome to the Phone Age

Yesterday's visionaries shocked their audience by proclaiming a distant reality of “a phone in every home!” Today's visionaries proclaim “a home in every phone!” And an office too, and with it—your school, your movie theatre, your bank!

Computers, entertainment systems, printers, home security control boards, exercise machines, all gradually render into generics—dumb boxes controlled, managed, run by . . . your phone.

Vast areas around the globe have no infrastructure to rely on—except a few cell phone towers. If they don't render the phones into their banks—they will have no banks, and no economic infrastructure.

To realize this advanced vision it will be absolutely necessary to create a seamless payment environment because whenever some people get together they normally wish to exchange valuables, deal, and trade, and wherever money is—fraud comes rushing in. That is why we, on the security end of things, need to do our homework.

Patchwork will not do, plumbing is a failed strategy. “You don't bring a knife to a gunfight” is the famous movie line that applies here. We must first recognize that this “life by phone” emerging paradigm represents a host of unprecedented opportunities to the bad guys. The phone is always on. Anyone can call you from anywhere, text you, upload from you, download to you, locate you geographically, and find out who are the people you talk to, and deal with. More than 60,000 mobile phones are simply left behind in taxis, every year, in New York city alone. Reportedly one in three Americans experiences a loss or theft of his mobile phone. We have encountered cases where a diner returned to the restaurant where he left the phone on the table minutes ago, and had it returned to him after its full load of data was copied away—unbeknownst to him. You may be very careful with your phone, but the person you share sensitive text messages with may not be. Today your phone makes you an instant merchant. If it is stolen, it's like you gave a thief access to your cash register. People buy and install a barrage of applets—how clean, how innocent are these programs?

The long term picture though looks pretty good. Money will mature into digital currency which may be crypto-secured to any degree necessary; identity theft will be thwarted by a plethora of means: the phone camera will take your facial image and the other party will perform facial recognition, and stress measurements to first verify that it's you who uses the phone, and second that you are not coerced to do so. The phone mike will grab your voice for personal identification, (and stress measurements). Other biometrics will hook up too. And new patents coming down the pike will data-disable the phone if it is not subject to carry around movements so that it cannot be compromised while you stow it, or leave it on your night table. Another patent keeps the phone running as long as it communicates with a chip that you wear like a necklace or a wedding ring—dead otherwise. So you don't lose your world when you misplace your phone.

In fact, the full force of identity verification and data security will be applied to the phone because the phone will become the smarts behind your computer system which will only provide screen, mouse, and keyboard. The phone will hold the confidential data to lock, unlock, and operate your home security, and pat feeding devices, etc. Forget wait-for-approval credit cards, smart anticipatory programs will pre-clear funds for cash-like digital currency transfers. Paper receipts will soon be replaced with screen-receipts. Today's cloud backup services will shift from your PC to your phone, so you can buy the newest hand-held gizmo, and download your previous phone data to it—on the go.

PC passé, plastic money will not stay. The age of the phone explodes right in our palm—the new home, the new school, the new entertainment, the new community center, and the new bank and payment center—the earlier you see it, the better you will fare.

### Mix-Fix Innovation

Topics of innovation and refinement of the concept:
Mechanical Design
Entropic Alphabet
Applications

### Mechanical Design

topics: holes pattern, building apparatus into host system, pressure and rotational speed coordination, cascading.

Holes Pattern:

The holes in both disks may be of any form and any shape, and different from hole to hole as long as there are some positions of overlap between the holes such that fluid can flow through the combined two discs. Yet, the smaller the average size of the combined holes, the greater the pressure that will have to be applied to generate a required throughput. It is therefore, conceivably to arrange the holes to generate the desired effect of desired level of mixture by creating a large as possible flow-through area.

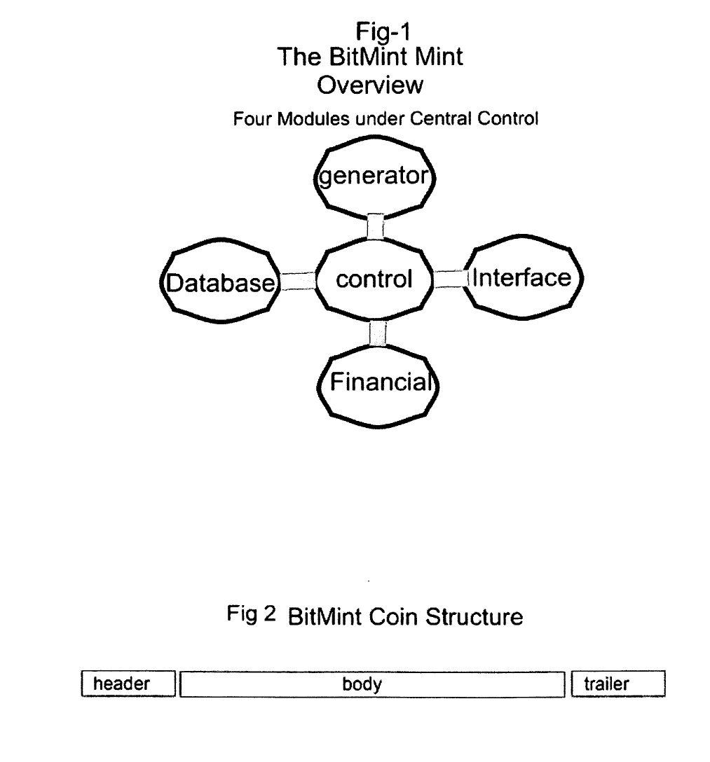

One of the discs, either the stationary, or the rotating one, might be designed with as much opening area as possible. This will be achieved for every chosen value of n—the number of holes along a certain radius. We have seen that n determines the angle for the normal holes, β. (See FIG. 1) since β=2λπ/n, where λ->1. n also determined the distance between the hole centers of two successive holes along a given radius, since that distance: d=r/(n+1), where r is the radius of the disc. This means that: 2b<d. Or say that for λ->1 and for b->d/2, for every value of n, A, the holed area in that disc approaches πr2. A→πr2. One could design discs with variable B values for each radius line, with variable d values between any two successive holes. To that end one may define the ‘normal hole's the hole that is of a shape of a polar element, meaning an element of area as defined in polar coordinates. That means that a normal hole will be defined by two arcs and two straight lines. The stationary discs will have n holes on every radius line, since there are n radius lines, there will be n2holes on that disc. The angle span of each hole will be of a maximum of β, where β=π/n. Since every hole has to be surrounded by disc material it is necessary for the actual angle span for the holes to be a bit less than B. The vertical distance for each hole may be variable as long as the summary of these distances for all the holes that share a radius line will be less than the radius r. It may be only slightly less to insure physical integrity of the disc. We can analyze the simple case where all the vertical distances for the various holes (2b) is the same. The holes configuration along all radius lines will be the same. So that if one radius line has holes of equal vertical size (2b), all the rest will have the same. If one radius line has various vertical distances among its holes, then all the other radius lines will have the same.

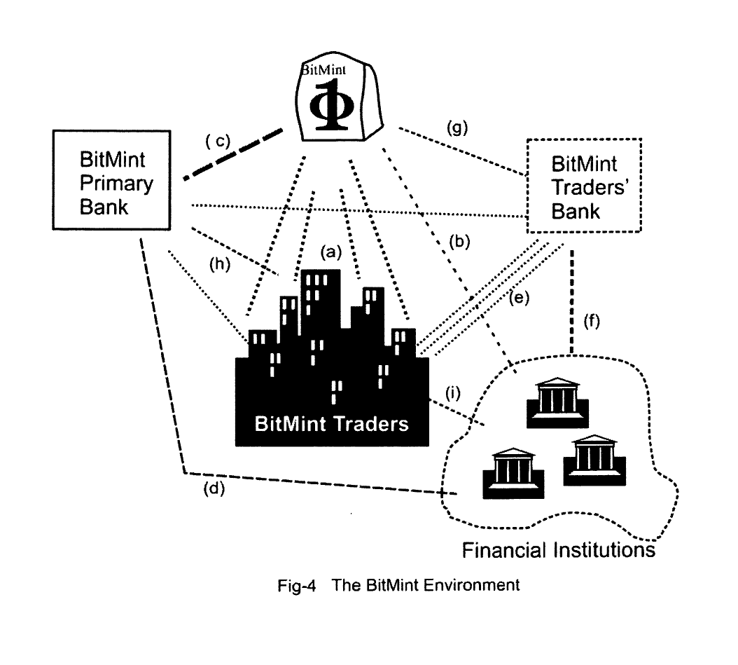

In general the rotating disc will have any number m (equal or different from n) of radius lines along each them there will be a single hole and no more. These holes (on the rotational disc) will be centered in correspondence with the respective hole on the stationary disc. If we mark the innermost hole on the stationary disc as placed at a distance s1 from the center of the disc, then a radius line on the rotating disc will have a hole at distance s1. And correspondingly for all the distances s2, s3, . . . . The angle of each hole in the rotational disc may be of same or different size as the corresponding hole in the stationary disc. We decide to pick one radius line on the stationary disk as line #1, and on it, the innermost hole as hole #1, or more comprehensively h(1,1)—meaning the hole on line #1, marked as hole #1. And then we mark successive lines on the stationary disc as lines 2, 3, . . . , n. So that h(i,j) will denote hole number j on line number i (i,j=1, 2, . . . n). The holes on the rotational disc will be marked as follows: g(1,1), g(2,2), g(3,3), g(k,k), where k=1, 2, . . . min(n,m). If m>n then the holes in the rotating disc will be marked as: g(n+1,1), g(n+2,2), g(n+j,j) where j=1, 2, . . . (m−n). where g(a,b) reads as hole number b in line number a. The above described a “single string” holes pattern. A double string hole pattern will have in addition the holes: g(1,(p+1) mod n), g(2,(p+2) mod n), . . . g(k, (p+k) mod n), where k=1, 2, . . . . min(n,m), and p=2. where a “mod n” result of zero will be interpreted as n. See FIG. 4. A third string can be defined as above with p=3, and so on for p=4, 5, . . . n−1.

In summary, the stationary disc will be filled with n2 holes denoted as: h(i,i) for i,j=1, 2, 3, . . . n and the rotating disc will be filled with holes according to the formula:

g(j,(p+j) mod n)

where j=1, 2, . . . m for the m radius lines in the rotating disc. The simple case, called one string corresponds to p=0. The two string case corresponds to p=1, and the w case corresponds to using the p values: 1, 2, . . . (w−1).

The holes patterns between the rotating and the stationary discs may be switched, if so desired. Different mixing aims with different mixing ingredients will be optimized by different hole patterns to the disc. Optimization can be carried out theoretically or experimentally.

Cascading:

The mixed flow that exists a given Mix-Fix station (apparatus) may be fed into another Mix-Fix device where additional mixing takes place. And this action can repeat itself, as many times as desired, achieving a mixing degree as advanced as desired.

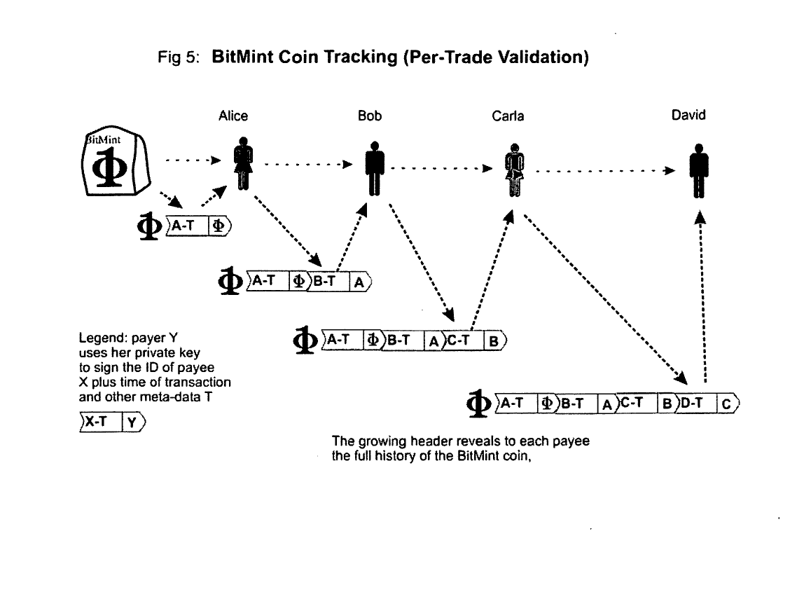

A serial cascade of Mix-Fix stations may also be used to allow for interim injection of a different ingredient which one wishes to put into the mix at this stage, perhaps after a slow or former reaction took place. See FIG. 5

Cascading can be used to effect a combined filtration. A fluidized bed comprised of solid pebbles and one or more gases can be mixed through a MixFix station with large enough openings, and the mixture is fed into a MixFix unit with small enough holes so that the pebbles eventually drop into a collection tray while the gases flow on.

Entropic Alphabet

writing messages

reading messages

The Language:

Principles:

Shapeless alphabet—letters are measured by (i) ratio between black and white (or other two distinct colors or discriminants), and (ii) the entropic quality of the dispersion between black and white.

Description of the Entropic Language:

Principles:

Shapeless alphabet—letters are measured by (i) ratio between black and white (or other two distinct colors or discriminants), and (ii) the entropic quality of the dispersion between black and white.

Entropy defined over a superficial distribution of two distinct colors measures the extent of intermixing thereto. If the two colors are arranged in only two zones, with a single borderline then their entropy is defined as zero. If the distribution involves smaller zones touching each other than the entropy is higher. In theory the entropy may rise to infinity because the size of the zones may approach zero, and whatever distribution one is claiming as associated with higher entropy may be further distributed cutting down the zones to smaller sizes, therefore claiming higher measure of entropy. Hence the maximum entropy in this context is infinity. The question arises then how to assign a measure to the dispersion, how to scale the entropy? Several possible ways come to mind, especially measuring the totality of borderlines between the two colors, let's call them black and white.

For some practical reasons the measure of entropy will be based on BiPSA concept. To that end we will define a baseline grid:

The surface where the two colors are painted will be overlaid with a Cartesian coordinates defined with a minimum interval for the two axes: Δx and Δy. These intervals will define the surface as a matrix of rectangular, called pixels. The division of the surface to these pixels will be regarded as the baseline grid.

Given the baseline grid, the maximum entropy is capped, unlike in the case before. If the two colors are of equal amount then the maximum entropy is associated with the case where every black pixel is sharing an edge with only white pixels, and vice versa. And similar definition for non equal amounts of colors.

Applying BiPSA:

Any point on the baseline grid (the matrix) has some neighboring pixels. Its color may be estimated by the color of these neighboring pixels. That estimate may be compared to the actual color. For a zone comprised of single color, this method will yield a lot of hits. Conversely, if a zone is comprised of mixed colors, say black and white, then many of such BiPSA estimates will be a miss. We therefore may regard the hit to miss ratio of such BiPSA estimates as a metric to express the degree of mixing of the two colors, or say the degree of entropy.

We now face the questions of (i) how to define the BiPSA estimate, and (ii) how to convert the hit to miss ratio to an entropy measure.

We can define a BiPSA procedure to estimate the color of each of the superficial pixels, and then compare the estimate to the actual color of that pixel. Then we can compute the number of ‘hits’ when the estimate is correct, over the number of estimated pixels (hits+misses), this ‘hit ratio’ will be a qualified metrics for the superficial entropy—the larger the hit to miss ratio, the smaller the entropy.

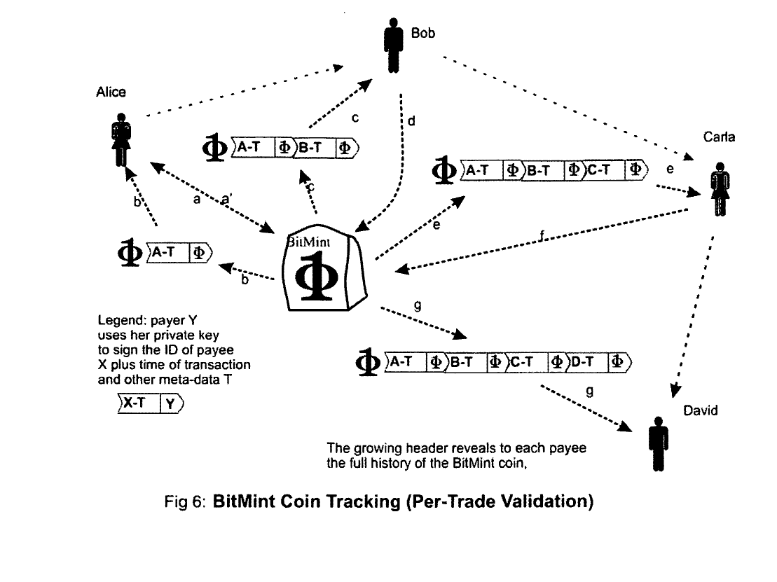

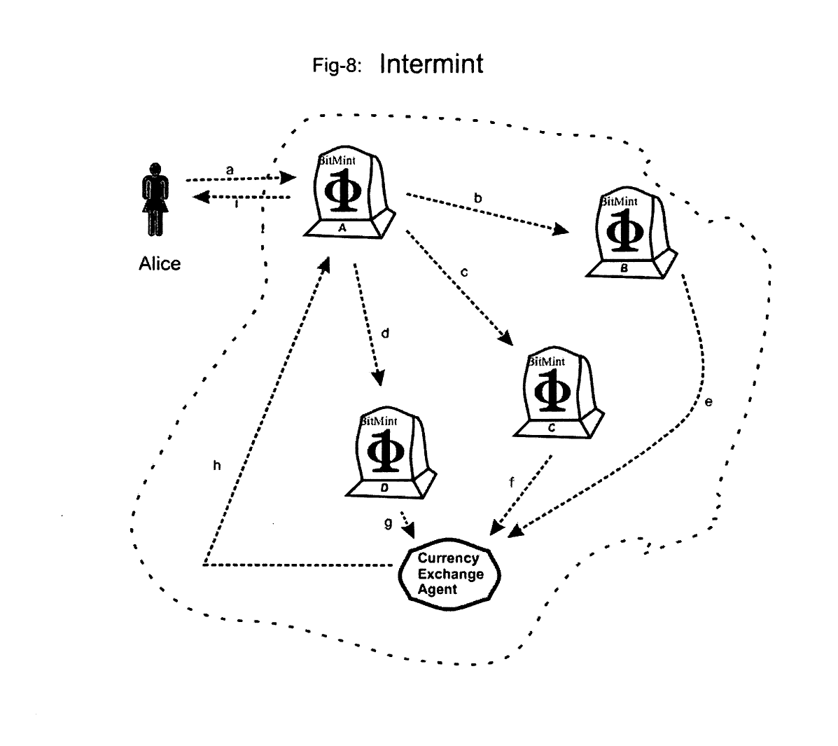

We may consider any number of BiPSA procedures. For example see FIG. 6, where the estimated pixel is marked with a “?” and the neighboring pixels used to estimate its color are marked by the weight used for them in the BiPSA procedure. The idea being that every pixel uses its own color to estimate the pixel to be estimated.

it is clear that for each of the depicted procedure, if the two colors are of equal area and intermixed to the maximum then each and every estimate will be wrong because each pixel is touching for pixels of the opposite color (except for the boundary pixels that have fewer neighbor). The minimum entropy is found in the case where one color is nonexistent and all the pixels are of a single color. In that case every estimate is correct—and the entropy is minimum. We can thereby define the superficial entropy for two colors distribution with baseline grid, c as follows:

ε=1−(h/(h+m))

Having defined entropy, we now face the challenge to use this definition to define symbols and letters to effect communication. This transition to letters and symbols depends on the resolution available to us for writing and for reading entropic messages.

One possible approach will be to use an equal area for the two colors, at different distributions for primary symbols, and then use non equal area for secondary symbols, like punctuation signs, money denomination etc.

### Defining the BiPSA Estimate:

We may consider any number of BiPSA procedures. For example see FIG. 6, where the estimated pixel is marked with a “?” and the neighboring pixels used to estimate its color are marked by the weight used for them in the BiPSA procedure. The idea being that every pixel uses its own color to estimate the pixel to be estimated.

So to estimate the color of a given pixel, we will give maximum influence to the 2, 3, or normally 4 pixels which share an edge with the pixel in question. The determination will be simple:

For corner pixels: if the two pixels sharing an edge with the pixel in question are of same color, then the estimate will be of same color. If they are of opposite colors, then the range of the estimators will be expanded, and include the single pixel that shares a vertex with the pixel in question. This will resolve the estimate in favor of the color of that third pixel.

For an edge pixel with three neighbors—there cannot be a stalemate, and the estimate will be according to the plurality of the colors of the three neighboring pixels.

For an inner pixel with 4 neighboring pixels sharing an edge there can be a stalemate. In that case the other four pixels that share a vertex will be added to the BiPSA estimating crowd. it would be a weighted BiPSA with a weight of 2 to the edge-sharing pixels, and a weight of 1 to the vertex sharing pixels. This configuration may result in a stalemate. in that case one will add the 16 pixels that surround the former 9 pixels. In that case the last 16 pixels will be given a BiPSA weight of 1, the four vertex sharing a weight of 2 and the four edge sharing pixels a weight of 3, or a similar setting.

This case may also end up with a stalemate. In that case one would add the next layer of pixels, and adjust the weights as before. If we agree that either the horizontal count of pixels or the vertical count in the area will not be an odd number, then this regressive procedure will guarantee us an eventual escape from this stubborn stalemate.

Alternatively one would a-priori count either all the pixels (with diminishing weights) as the BiPSA crowd source for estimating a pixel's color, or any arbitrary number of layers.

### Converting Hit-to-Miss Ratio to Entropy Measure:

The rational for BiPSA was the idea that zones of same color pixels will yield a high count of correct estimates, and highly dispersed zones will yield a low hit to miss ratio, so that this ratio (h/(h+m)) may be worked out to represent degree of mixing, or entropy.

This general reasoning faces some difficulties. Consider a chess board with alternating black and white checkers—representing pixels. Since each black is surrounded by only white pixels sharing an edge, and vice versa, then the BiPSA method will yield a zero hit to miss ratio. Alas, if we simply use a PRNG to estimate the colors of the board, and if the board was colored completely randomly then the hit to miss ratio would be 0.5. So we reach here an absurd where we put in place a ‘smart estimating procedure’ and get accuracy much less than a completely random estimator. And after all, a perfectly organized chessboard is not a case of poor predictability or poor entropy.

This teaches us that in interpreting the hit to miss ratio, what matters is the deviation from randomness, meaning the deviation from 0.5. So if we have a hit to miss ratio: R=h/(h+m) then we may define its corresponding entropy as: ε=2*(|R−0.5|)

So that for R=0 or R=1—all misses, or all correct, the entropy is highest, and it is minimum for R=0.5.

Writing Entropic Messages:

Writing Messages Needs a Discussion Regarding:

letters definition

message description.

### Letter Writing:

We May Write Letters in Two Methods:

per-pixel computation

physical mixing

### Per-Pixel Entropy Computation:

The idea here is to compute the pixel identity of a given area, then use computerized means to paint a similar area with pixels in the right identity and create an area of the desired entropy. What is needed here is a means how to decide the identity of a given area (pixel wise) so that the desired entropy will be read by the agreed upon BiPSA procedure.

Such Procedure Might be:

stochastic

deterministic

### Stochastic Entropy Computation:

The basic idea in stochastic letter writing is as follows:

Given a pixel array (a matrix of pixels) of size n*m pixels, use tow colors black and white to mark the pixels in such a way that the agreed upon BiPSA procedure will rate the matrix with a desired entropy ε.

The stochastic way to achieve this is by using a stochastic algorithm to paint the n*m pixels. In analyzing this task lets first assume that the overall quantities of the two paints is the same. Let's further assume that we wish to paint the surface, the area, to achieve maximum entropy (greatest dispersion). We would then use a PRNG to decide each pixel in turn whether it is black and white. This, according to probability theory will yield a maximum entropy.

Since each pixel was painted independently and according to high quality PRNG, the expected hit to miss ratio will be 0.5. We wish to normalize the entropy so that the highest level of it will be 1, we may define:

R_{w}=h_{w}/(h_{w}+m_{w}) and R_{b}=h_{b}/(h_{b}+m_{b})

as the hit ratios for the colors black and white (“b” and “w”).

Clearly: R_{w}+R_{b}=1

So we agreed that we could generate a maximum entropy surface using a PRNG. if we wish to generate a pixelized surface with any desired entropy c, using equal quantities of paint (meaning equal number black and white pixels), then we should assign 0.5*n*m white pixels and the same number of black pixels. At any moment of assigning pixels to one color or the other there are still F_{w} free white pixels to assign and F_{b} black pixels to assign. We can use a PRNG and assign the matrix pixel by pixel using probability rating proportional to (i) the hit ratio corresponding with the target entropy, and (ii) proportional to number of remaining free pixel of the respective color to be assigned.

The rational for the above formula is as follows: A low entropy will require a succession of same color pixels. This will happen if we modify the PRNG process with a hit ration off the rate of 0.5, preferring one color over the other. But so doing will exhaust the preferred colors pixels faster than the pixels of the opposite color. So by also modifying the PRNG (pseudo-random numbers generator) to be proportional to the remaining same color pixels to be assigned, we create a situation that for coloring the latter pixels in the n*m count the other color will come in same-color succession because it will have more pixels to be assigned because early on the other color got the preference.

So for each pixel in turn the PRNG will be modified by the probability P_{W} to have it assigned as white by: P_{w}=k*F_{w}*R_{w}

And similarly for assigning black such that k is some coefficient of proportionality.

When we employ any estimating procedure for pixel colors and the hit ratio deviates from 0.5 up or down, we encounter a lower entropy. If we wish to assign the maximum entropy as 1 and the minimum entropy as 0 we may want to use the following formula for entropy:

ε=2*(0.5−|R−0.5|)

where R is either R_{b} or R_{w}.

Since: |R_{b}−0.5|=|(1−R_{w})−0.5=|0.5−R_{w}|

this formula for entropy is consistent with the desired boundary values.

The chance for assigning the next pixel to be black is:

π_{b}=P_{b}/(P_{b}+P_{w})=kF_{b}R_{b}/(kF_{b}R_{b}+kF_{w}R_{w})

With this assigning formula one can assign the entire surface some s times, then BiPSA process the matrix to compute its entropy for each of the s times. For s being sufficiently large there will be two instances of filling up the matrix that would be with entropy a₁₁ below the target entropy ε_{target}, and with entropy ε_{H} above the target such that the distance between the L-low and H-high entropy will be the smallest among the s cases.

This is a highly heuristic way to generate several matrices of pixels computing to various values of entropy, from which to narrow the pixel board towards the desired entropy. An alternative way also presents itself:

The Resolution-Downgrade Method:

Suppose we reduce the present resolution of the board (which is n*m pixels) to a lower resolution of n′*m′ where n′=n/u and m′=m/v, where u,v=1, 2, 3, . . . . Then we fill up the lower resolution board with a simple PRNG. Clearly the low-resolution setup, if evaluated in the full resolution setup of n*m will show a low entropy, and the higher the values of u and v, the lower the evaluated entropy with the full resolution board. So it would be easy to compute s cases of varying entropy values such the target entropy will be between two cases of maximum proximity (in terms of entropy value). And now we come to the challenge of how to derive a case of exactly or close enough to the target entropy from these “a bit too low” entropy and “a bit too high entropy”.

The next task is to compute an in between matrix assignment to create an assignment with the target entropy.

### Stochastic Illustration:

Let's start with the simplest case 1 over 2 board: two pixels. we have one white pixel to assign and one black pixel to assign. Using a PRNG, say white is selected for the first pixel. for the second pixel the PRNG will have only one black pixel to choose from, so the second pixel for sure will be black. Now the board is: W B. using BiPSA the white will estimate the black as white and vice versa so both will be wrong so the hit count is zero, and the entropy will be zero.

Indeed there is no room for equivocation. The only two possibilities for the board are W B and B W.

Now let's see the case of a square. See FIG. 7. The steps illustrate how a PRNG works and insures that the number of white pixels equals the number of black pixels because the PRNG takes aim at the set of colors remaining to be assigned. The illustrated result:

$$\begin{matrix}W & B \\ W & B\end{matrix}$$

may also illustrate the fact that the basic BiPSA procedure will not work here, because each pixel is surrounded by two pixels of opposite colors to create a resolution of ‘undecided’ for all pixels. But by using the procedure that includes the diagonal pixel, we get wrong estimate for all pixels—or hit ratio of zero percent which translates to zero entropy.

The concept of applying stochastic selection will work on every pixel matrix, on any ratio of pixels between black and white. The PRNG will successively choose the color of the next pixel, and do so from the dwindling list of black and white pixels. So at the end of this procedure it is guaranteed that the matrix will be filled up with the desired ratio between white and black pixels. For example consider a 6 by 6 matrix, and a desired ratio between white and black to be 14/22. We will have then a starting set of 14 white pixels, and 22 black pixels. The PRNG will select one of them to fill in the first of 36 slot of matrix. The selected one will mean that the selected color has one less now for the next selection of the PRNG. Here below are four examples for how a PRNG filled up the 6 by 6 matrix with 14 white pixels, and 22 black ones.

$$\begin{matrix}B & B & W & B & W & B \\ B & B & B & B & B & B \\ W & W & W & B & B & W \\ W & B & B & W & B & B \\ B & W & B & W & B & B \\ W & B & W & B & W & W\end{matrix}$$

$$\begin{matrix}B & W & W & W & B & B \\ W & W & B & B & W & B \\ B & B & B & B & B & B \\ B & W & B & B & W & B \\ B & B & W & W & B & B \\ W & W & B & B & W & W\end{matrix}$$

$$\begin{matrix}W & B & B & B & B & W \\ B & B & B & W & B & B \\ W & B & W & B & W & B \\ B & B & W & W & B & B \\ W & B & W & W & B & B \\ B & B & B & W & W & W\end{matrix}$$

$$\begin{matrix}B & W & W & B & B & B \\ B & W & W & B & B & B \\ B & B & B & B & B & W \\ B & W & B & B & W & W \\ B & B & B & B & W & B \\ W & B & W & W & W & W\end{matrix}$$

### Entropy Approximation:

The objective is to paint a pixelized matrix with a target entropy measure as defined by the respective BiPSA procedure. We mentioned above that we may use the resolution-degrading to paint the original matrix at a full range of entropy from 0 to 1. By so doing we will define two ‘embracing’ paintings that would be closest together than others and that would have one entropy reading below the target and one above, L and H reading so that the target entropy T is: L<T<H.

The task now is how to paint a matrix with a first approximation of T, namely T′ such that: L<T′<H. to do that we shall cut a half of the L painting, and half of the H painting and concatenate the two halves. This creates uncertainty as to entropy contribution of the contact lines. We therefore may use a PRNG to reassign the colors of the two border lines from each of the concatenating ingredient. Doing so sufficient number of times we will identify to paintings with values L′ and H′ such that: L′<T<H',

<(H′−L′) where>

### Physical Mixing:

Using the MixFix device one would experimentally build a relational table that would connect pressure applied, speed of rotation to a resultant entropy of a mixture of two given paints over a given Mix-Fix device. This table would then be used to write any desired letter by adjusting the speed of rotation of the rotating disc.

This method of physical mixing based on an experimental calibration also suggests that all letters of the desired alphabet will be defined per a given ratio of total amount of each color, preferably equal amounts of black and white to give maximum range for the entropy. That is because it functionally easier to keep the ratio fix and change only the speed of the rotating disc, and nothing more, in order to comprise a string of letters.

In such physical mixing (physical entropic writing) one will have to determine the amount of time to maintain a given rotation speed—that would determine the amount of mixed paint that would exhibit that particular letter from the alphabet. The longer the time for a given rotation speed, the longer the stretch of mixed pain that would emerge from the Mix-Fix device, and hence the longer the stretch on the painted surface that would show that particular letter. On the other hand, the longer the disc rotates in a given speed, to write a given letter, the longer it takes to write the full message, so some sort of compromise is needed. However, the above give a complete functional description for how to write entropic letters using physical mixing of two points.

it is expected that there would be in practice between 4 to 8 degrees of clear discrete no confusing levels of entropy setting (letters), which means that messages could be written in an alphabet of 4 or 8 symbols. This is to cover the range from equal quantities for the two colors to one color virtually disappearing. Alas, that range may be doubled, because each of the colors may be disappearing. Yielding an alphabet range of 8-16. A 16 range is especially attractive since it fits into the ASCII table structure.

Using the MixFix apparatus one would experimentally build a table that would link rotational speed of the rotating disc to resultant entropy. The result will depend on the apparatus, the hole patterns in the discs etc. Once the table is constructed, it will serve a computer program that would read a message, translate it to the MIXFIX alphabet, and then guide the rotating disc to rotate with the speed dictated by the table that ties speed of rotation with resultant entropy given the viscosities of the mixed ingredients, and hole patterns.

In some cases it is of advantage to use brush and spray to mark surfaces in entropic writing.

### Brush & Sprayer Entropy Writing:

it is possible to write entropic messages without using an advanced Mix-Fix device and instead using only a simple brush or common paint sprayer, several paints and a surface to paint on. One simple method is described below:

Entropic-54

Using three colors to write an alphabet consisting of 54 letters, which is sufficient for the 26 letters of the English alphabet, its 10 digits, and some extra 18 symbols of choice.

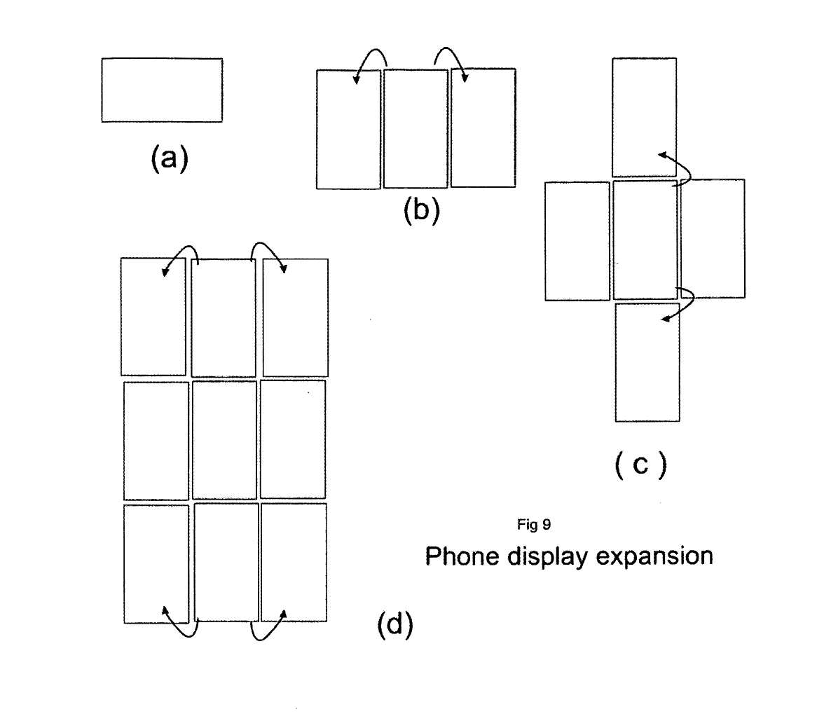

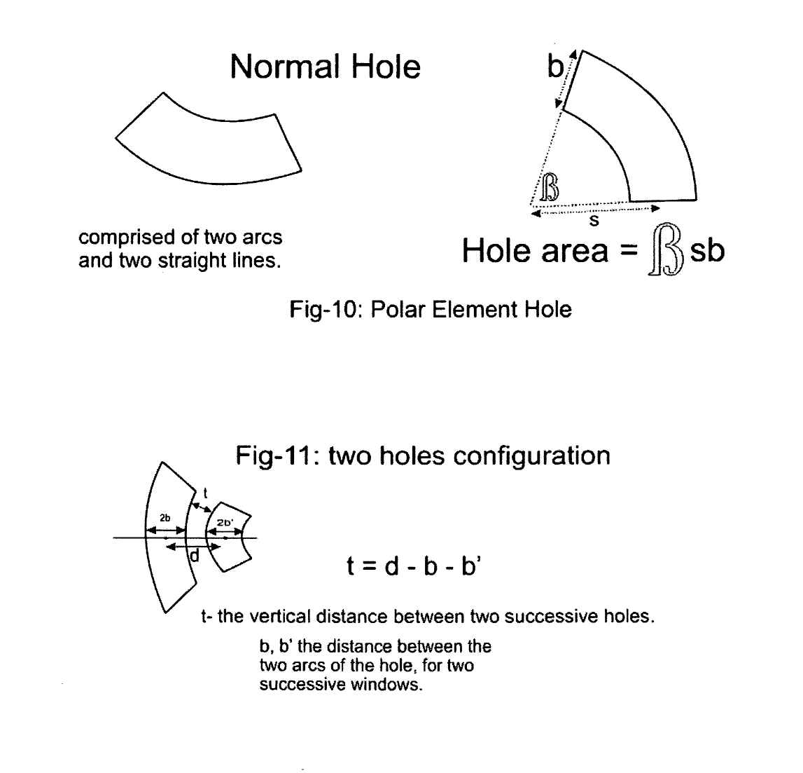

To apply one would use three brushes of three different widths, or sprayers with proper opening. One would be able to apply the brushes sparingly or fill up the area (without losing sight of the brush width), or any in-between fill measure. One would then use 3 colors for the brushes, and two background colors. This computes to 3*3*3*2=54. See FIG. 9

### Message Description:

Given a message comprised of n letters or symbols, each expressed as an entropic zone, the question arises as to how string them together to communicate the start and finish of the message.

One way to do so is by devising a header and a trailer graphics and append them appropriately over the entropic string.

Another way is to mark a center point from where to write an outwardly spiraling string of letters.

Many other conventions may apply.

Reading Entropic Messages:

The first question of interest here is resolution. In the extreme case the matrix is seen as a single pixel, which resolves to either black or white, and no letter, no message can be retrieved. In the other extreme the reading pixels will be of much higher resolution than the writing resolution, and the entropy reading will be also distorted.

One way to handle this challenge is to attach a resolution meter to each entropic message. The meter will be constructed from black and white lines parallel to each other. When the reader can distinguish the separate lines but when moving further away the distinct lines become a single grey stain, then the reader is viewing the entropic message with its base resolution. In general though the message writer will set the resolution towards the expected resolution of the message reader.

Once the right resolution is used the entropic message is captured in a pixelized matrix on the reading camera, and these pixels may be software processed to apply the agreed upon BiPSA procedure and compute the reading entropy.

Further Research into Entropic Coding:

We may further research as follows: multi dimensional entropic encoding, resolution variation, applications, string encoding, Multi-color entropic alphabet, Non-visible light entropic distinction, Entropic reading boundary—shape reading

Multi-color entropic alphabet:

if a surface is marked with n colors, not just n=2 colors, then each color may define entropic letters versus all the other colors. Namely color 1 will be judged versus colors 2, 3, . . . n as if they were all color 2. This will allow a board to encompass many letters in the space that without this it would be only one letter.

How to: The Iterative Multi-Color Procedure: First paint the entire canvass with color 1. Then paint on the canvass areas with color 2, so that the relationship between what remains colored with color 1 and what is colored with color 2 represents the desired entropic symbol. Then you use color 3 to cover the part of what has remained from color 1 so that color 3 v. the rest of the canvass will mark the desired entropic letter. Next one is to mark color 4 on what is left of color 1 (after the original area was decreased with colors 2 and d3 markings), so that color 4 v. the rest of the canvass will mark the desired entropic symbol. And so on until color n.

Qualifications: the iterative procedure above limits the range of letters available for marking for each successive color because the successive colors have only the residual area under color 1 to mark on, and they all have to leave intact the area painted by the former colors.

To apply the iterative procedure it is best if the alphabet is restricted to low area to area ratios, which in turn restricts the range of symbols for that area ratio.

Applications

multi-phase mixing

catalytic reaction

kinetic control of chemical and physical processes

entropic labeling

Kinetic Control of Chemical and Physical Processes:

It often happens that a reaction or a process is desired to be carried out at a desired pace, and such pace may be determined by the extent of mixing of two, say, chemical ingredients. And hence Mix-Fix will come in handy.

Entropic Labeling

Entropic Labeling has the Advantages of:
easy computer interpretation
easy reading from various directions, at various levels of visual obstruction
discriminating between more important and less important information.

Regular letters are hard to interpret for computer. Entropic messages are easy. Important information may be painted with a lot of contingency and on large area, and less so for less important information. Applications:
industrial site control
traffic control
preventing friendly fire
disaster relief efforts.

Construction sites have carts, lumber, boxes, equipment etc. all strewn about. If such items are marked with entropic labels then a quick helicopter ride will track them all. Similarly for ground tracking. Cars may be identified by an entropic patch on their roof, allowing for vertical placed fail camera to identify such vehicle and monitor them for speed or other violations. Our soldiers may be dressed with entropic labeled uniform preventing a camera-equipped gun from shooting them by mistake. In a disaster situation where people are trapped in an area covered with smoke and suit, they will be able to spray mark a balloon with a ‘rescue me’ message or any other message, and fly the balloon above the smoke covered area. The message on the balloon will be spotted by a rescue chopper from just about every direction. Alternatively the trapped people could spray the entropic message on the ground

Other Entropic Language Applications:

regarding application not connected with Mix-Fix apparatus:

monitoring visuals on array of screens

interpreting photographic plates

Monitoring visuals: in security situations a guard may be called to simultaneously watch an array of screens representing several cameras. The more cameras there are the greater the chance that something deserving attention will happen before a certain camera, without attracting the attention of the guard. By constantly processing any transient picture for its entropic reading, the computer will alert the guard to screens where a sudden shift was computed in the visual. The entropic shift is not shape specific, and will catch anything in proportion to the actual change. it is especially important for visuals that report high traffic because the entropic reading is not sensitive to certain bodies changing their position or moving about.

X-ray plates, or air photography and others share a challenge of checking a convoluted complexity of dots and shapes with the aim to identify whether a given target body is present there, covered, or camouflaged. Using entropic coding it is possible to code the shape of a suspected item, and then scan with a “moving window” the plate, or the picture to check if somewhere there is a reading of a window with the same entropic coding in various resolution.

### LIST OF DRAWINGS

Drawing #1: The BitMint Mint Overview: depicts the high level functional building blocks of the mint: central control, coin database, financial center, the coin generator, and the interface with the sources of queries.

Drawing #2: BitMint coin structure: a high level breakdown of the bit string that comprises the coin: header—body (or payload)—and trailer.

Drawing #3: “pay-as-you-go”: depiction of real-time digital money payment arrangement for any utility, which closes down when no money is paid upon consumption of that utility.

Drawing #4: The BitMint environment. The cross configuration between BitMint, its primary bank, its traders' banks, and other financial institutions.

Drawing #5: BitMint coin tracking (per trade validation). A depiction of the accumulating trading history as attached to the traded coin.

Drawing #6: BitMint coin tracking (per trade validation), II: an alternative depiction of the dynamics of tracked coin among many traders.

Drawing #7: account wallet configurations: drawing removed.

Drawing #8: Intermint: a configuration of mutually trading mints.

Drawing #9: phone display expansion: various degrees of expanding a phone screen,

Drawing #10: Polar element hole: depiction of the geometry of a polar element hole.

Drawing #11: two holes configuration: the relationship between two successive polar element holes.

Drawing #12: rotating disc holes pattern: the configuration of holes in a mix-fix rotating disc.

Drawing #13: stochastic entropic writing—marking different symbols based on stochastic marking, using two colors.

Drawing #14: brush and spray entropic encoding: how the color distribution levels allow for various symbols to be marked and communicated.

Drawing #15: Entropic Communication: writing and reading symbols expressed via entropic values rather than via shapes.

Drawing #16: Entropic messages painted on the curved surfaces of balloons—allowing for accurate reading from any direction.

What is claimed is:

1. A method to construct a viable digital currency server network (intermint) where independent mints mutually honor each other minted digital coins so as to appear to the trader as if the independent mints are a singular unified mint.

2. A method to construct a viable digital currency server hierarchy where subordinate nodes have sufficient information to authenticate and redeem a bona-fide digital coin, while not having enough information to defraud the higher up, or lateral nodes in the hierarchy.

3. A method to construct a digital currency mint where the coins are minted only upon demand, and where the image of the coins is secured with a write-once media, and where the terms of payment are encoded into the minted coin, and where the coin is expressed in a media-independent way, and where a physical coin is protected by a tamper-resistant technology.

4. A method as in (3) where the physical coin is encapsulated in mixed composite manufactured via the entropic controller mechanism where any number of ingredients may be mixed to a uniform entropy that resist emulation without knowledge of the mixing key.
